(19) United States
(12) Patent Application Publication
(10) Pub. No.: US 2012/0186154 A1
(43) Pub. Date: Jul. 26, 2012

(54) Automaton for Plant Phenotyping

(76) Inventors: Philippe Guerche, Saint Cyr l'Ecole (FR); Christine Camilleri, Paris (FR); David Bouchez, Cachan (FR); Hervé Balasse, Saint Remy les Chevreuses (FR)

(21) Appl. No.: 13/256,152

(22) PCT Filed: Mar. 15, 2010
(86) PCT No.: PCT/FR2010/050460

§ 371 Date: Oct. 12, 2011

(30) Foreign Application Priority Data
Mar. 16, 2009 (FR) 0951653

(51) Int. Cl. A01G 9/00; A01G 25/00

(52) U.S. Cl. 47/65

(57) ABSTRACT

The invention relates to an automaton useful in cultivating or phenotyping a plurality of plants in a controlled environment, including a plate on which a plurality of movable cultivation substrate holders is placed, said movable holders being capable of consecutively taking every possible position on the surface of said plate. The invention also relates to a facility useful in cultivating or phenotyping a plurality of plants in a controlled environment, particularly including said automaton, and further to a method useful in cultivating or phenotyping a plurality of plants in a controlled environment.

### FIELD OF THE INVENTION

The invention relates to the field of automatons that can be used for cultivating or phenotyping a plurality of plants in a controlled environment.

### PRIOR ART

The phenotype of a plant results from the expression of its genes in a given environment.

Hence, even under identical cultivation conditions, plants with different genotypes will have different phenotypes. As for genetically-identical plants, if they experience exactly the same climate conditions as they grow, they should have identical phenotypes. Conversely, if they are cultivated in different environments, they will have different phenotypes.

When studying a trait within a plant population, it is important for all of the plants being studied to benefit from the most homogeneous cultivation conditions possible, so that the phenotype's genetic components may be clearly identified and the amount of variation in the trait caused by the environment is minimized.

Such a need exists when performing cultivation assays for observing the adaptive response of plants to specific cultivation conditions, in order to determine the genetic factors involved in this response. Indeed, one of the situations for which phenotyping assays are performed on large sets of plants, which may reach several hundred plants, consists in identifying the genetic and physiological bases for the adaptive response of a plant species to stresses in its environment.

Knowing the genes and proteins involved in plants' adaptive responses to determined environmental conditions makes it possible to explore the biochemical functions of these genes or proteins, their regulation, and their organization into interaction or regulation networks, which may make it possible to generate ecophysiological or evolutionary models.

Such studies attempt to determine the genetic differences that explain the respective phenotypic differences among the plants. If climate conditions are not set such that they are identical while the plants are cultivated, it is impossible to know how much, in their respective phenotypes, is due to the genetic component and how much is due to the differences in climate conditions that these plants experience.

As a result, in assays of this type, it is crucial to be able to control as precisely as possible the homogeneity of the environmental conditions to which the test plants are subjected, in order to reduce the variation in traits being studied caused by uncontrolled fluctuations in cultivation conditions, such as light, temperature, or relative humidity levels. If such conditions are created, the phenotypic differences observed among the various plants will then reflect solely their genetic differences, and it will therefore be possible to access the genes involved in the observed trait.

Typically, in a plant cultivation assay under controlled-environment conditions, all of the plants to be cultivated are placed inside a confined cultivation enclosure, e.g., inside a greenhouse, or preferably inside a cultivation chamber that has means for controlling parameters such as lighting, temperature, and relative humidity; these parameters are set at selected set points and kept as homogeneous as possible within the entire space of the enclosure occupied by the plants.

While effective technologies for phenotyping certain major traits on a large scale do currently exist, options for cultivating plants in a homogeneous environment are, however, still limited, specifically due to the climatic microvariations that exist within a cultivation enclosure, including a cultivation enclosure equipped with sophisticated means for controlling environmental conditions such as temperature, relative humidity, lighting, etc. Indeed, local variations, on the centimetric scale, in environmental conditions are extremely difficult to control precisely, even inside a confined enclosure. Hence, at present, it is only possible to set an average global climate for the entire space of the enclosure. The effects of microvariations on environmental conditions lead to major phenotypic disparities, particularly for small-size plant species such as the model species Arabidopsis thaliana. For example, due to said climatic microvariations, no matter how minor they may be, genetically-identical plants may have different phenotypes, thereby leading to the erroneous conclusion that these plants are genetically different.

It is clear that, in the thriving field of plant phenotyping, certain analysis systems currently in use are satisfactory in terms of precision, such as means for weighing and analyzing relevant phenotypic traits, e.g., using cameras and digital image analysis equipment.

Variable-capacity plant-phenotyping devices that are equipped with a plant circulation system for transporting plants to an automatic phenotyping station that is generally equipped with a lighting device and at least one camera are known, for example. These plant-phenotyping systems automate the measurement of major parameters for studying plant growth and morphology, such as biomass estimation and plant color, identifying damaged areas, and plant architecture analysis. A method for automatic evaluation of green plants using a digital image is known from document EP 1,154,370, for example.

In some of these phenotyping devices, the plants are placed onto a motorized roller conveyor that follows a closed-circuit path; the conveyor device allows a given plant to travel past the phenotyping station once every 24 hours. These types of phenotyping devices, which occupy a great deal of space, are necessarily installed inside a greenhouse where, on the one hand, the global climate is difficult to control and, on the other hand, where the climate cannot be identically reproduced over time. In other phenotyping devices, the plants are moved only during weighing and therefore remain immobile, at a given location inside the cultivation enclosure, for most of the study period. As a result, in current devices, the climate conditions experienced by the plants are not sufficiently homogeneous to enable in-depth phenotypic studies.

A need exists in the state of the art for methods and devices for cultivating or phenotyping plants that are alternatives to or improvements on current methods and devices. Specifically, a need exists for methods and devices for cultivating or phenotyping plants wherein essentially-identical environmental conditions would be applied to plants throughout the entire duration of the cultivation or phenotyping assay.

### SUMMARY OF THE INVENTION

This invention provides such a device for cultivating or phenotyping plants whose specific characteristics dramatically reduce variations in environmental conditions applied to plants throughout the duration of cultivation or of the phenotyping assay.

According to the invention, the application, to a given plant, of environmental conditions that are essentially identical to those applied to each of the other plants that are being cultivated or tested at the same time has been achieved thanks to an automaton device and to a method enabling each of said plants to occupy consecutively, several times daily, each possible position on the cultivation or assay surface. Hence, using the automaton device and method of the invention, the same environmental conditions are statistically applied to each of the cultivated or tested plants throughout the entire duration of the cultivation or phenotyping assay.

As will be specified in the detailed description of the invention, the automaton device of the invention enables simultaneous cultivation of a large number of plants while occupying a smaller surface area. Said automaton device can therefore be installed inside a conventional-size cultivation enclosure. The way in which the plants are arranged on the usable surface area of the automaton, in combination with the geometry of the loop circuit for moving the plants over nearly all of said useful surface area, are what enable the application of extremely homogeneous environmental conditions.

This invention relates to an automaton having specific characteristics that can be used for cultivating or phenotyping a plurality of plants inside a controlled environment; said automaton includes a plate on which a plurality of movable holders are arranged as a cultivation substrate; said movable holders are able to assume consecutively all possible positions on the surface of said plate.

The invention also relates to a facility that may be used for cultivating or phenotyping a plurality of plants inside a controlled environment, specifically including said automaton.

The invention additionally involves a method for cultivating or phenotyping a plurality of plants inside a controlled environment, wherein the above defined automaton is implemented.

### BRIEF DESCRIPTION OF THE DRAWINGS

FIG. 1 is a general top-view diagram of a specific embodiment of the automaton.

FIG. 2 is a series of three top-view diagrams illustrating the series of steps of an embodiment of the plant cultivation or phenotyping method of the invention. The diagram in FIG. 2A illustrates an embodiment of Step a) of the method. The diagram in FIG. 2B illustrates an embodiment of Step b) of the method. The diagram in FIG. 2C illustrates an embodiment of Step c) of the method.

FIG. 3 is a synthetic diagram of the series of command and control steps performed in an example of how a cycle for cultivating or phenotyping a plurality of plants proceeds.

FIG. 4 shows the cumulative weight-loss curves for each clod in a set of 735 clods that undergo, respectively:

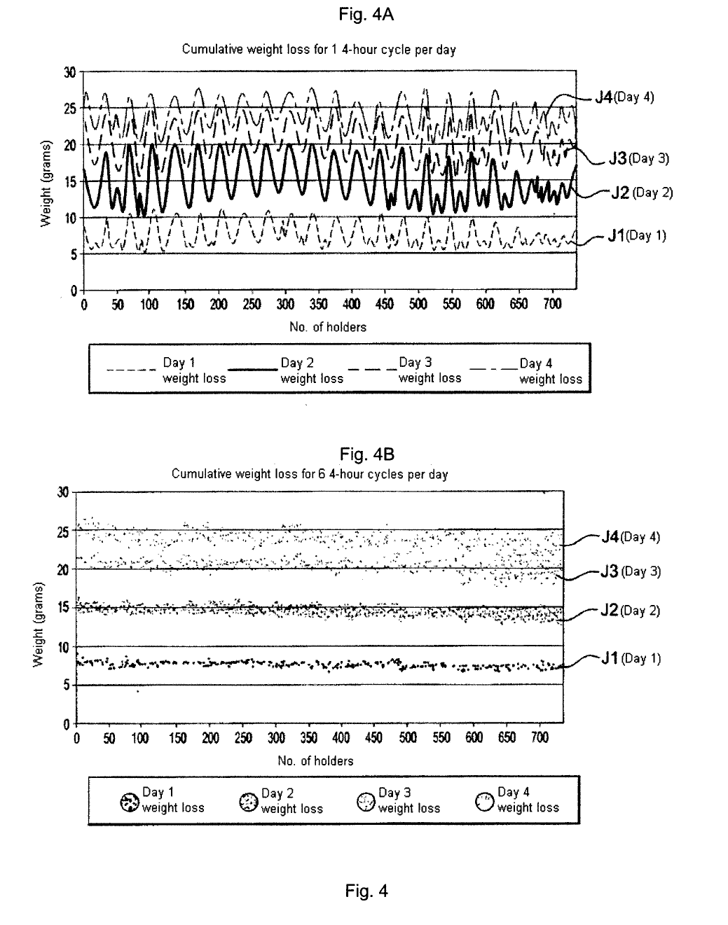

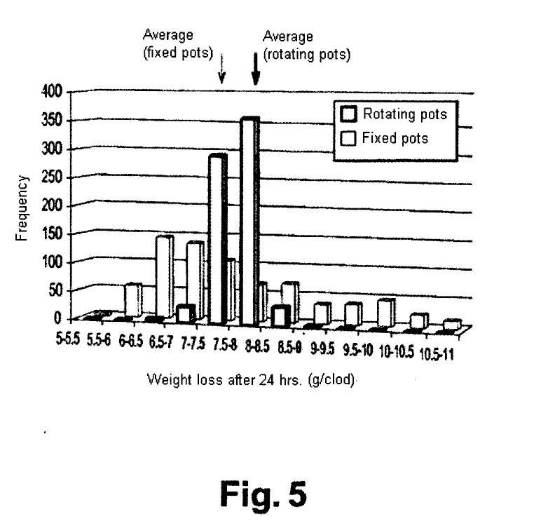

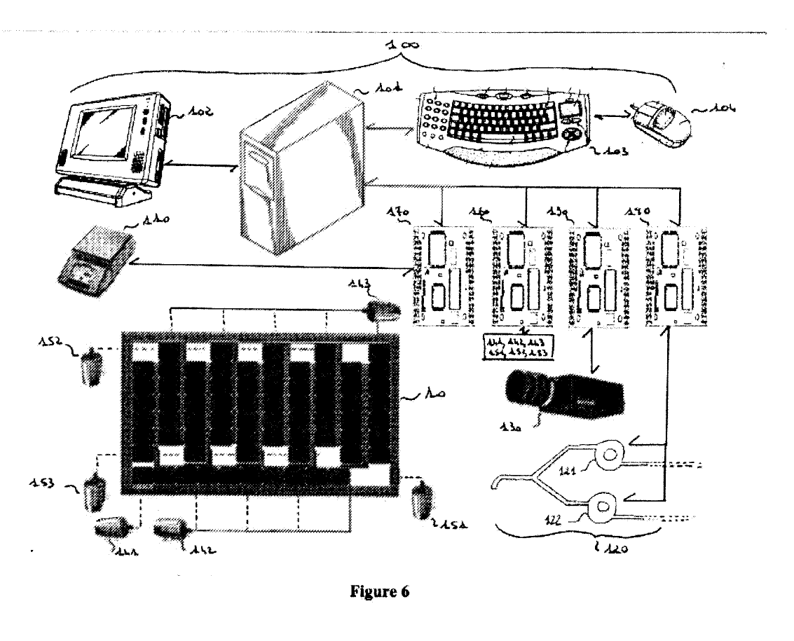

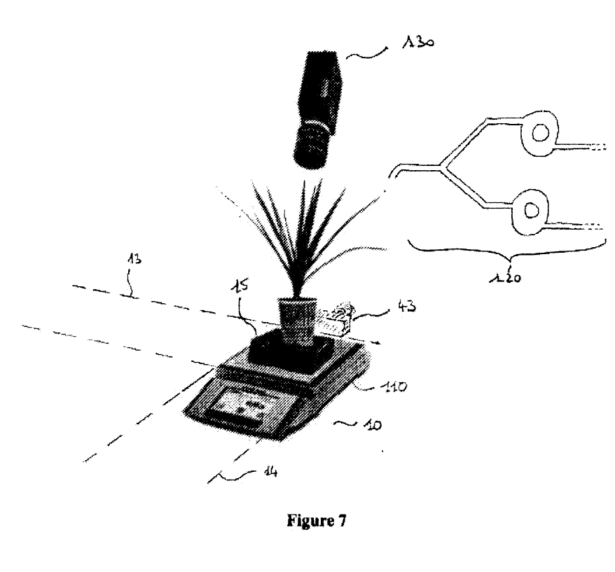

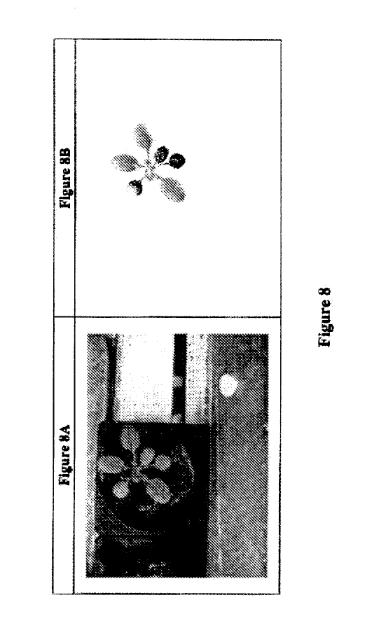

one 4-hour displacement cycle per 24 hours (FIG. 4A), or

six 4-hour displacement cycles per 24 hours (FIG. 4B).

X-axis: identification number of each clod tested, with 735 clods used during the assay; y-axis: weight loss for each clod tested over 24 hours, listed in grams.

Expanding on FIG. 4, FIG. 5 shows the weight loss curves after 24 hours for a set of 735 clods that undergo, respectively:

one 4-hour displacement cycle per 24 hours (fixed pots), or

six 4-hour displacement cycles per 24 hours (rotating pots).

X-axis: frequency (or number of clods), with 735 clods used during the assay; y-axis: weight loss after 24 hours, listed in grams per clod.

FIG. 6 shows a diagram of an embodiment of a cultivation and phenotyping facility of the invention.

FIG. 7 shows a diagram of a specific embodiment of the facility in FIG. 6, wherein weighing means, a camera device, and means for supplying water and/or fertilizer solution are placed in a single location along the plant displacement circuit.

FIG. 8 shows a digital photo of a plant taken by a camera device installed along the plants' route (FIG. 8A) and the image of its leaf surface area that is extracted from it following automatic image analysis (FIG. 8B).

### DETAILED DESCRIPTION OF THE INVENTION

The applicants have observed that, with known automatons for cultivating or phenotyping plants, significant variability existed in the cultivation conditions to which each of the cultivated or tested plants were subjected. The applicants therefore determined that the characteristics of known automatons led to the plants being immobilized in a given location of the cultivation enclosure during most of the assay's duration. Hence, with known automatons, each of the cultivated or tested plants was subjected to specific local environmental conditions that were distinct from the environmental conditions to which each of the other cultivated or tested plants was subjected. This resulted in a variation in growing conditions for each plant out of all of the tested plants that was likely to introduce significant differences into the growing speed of each plant or into other characteristics of the plants. These characteristic differences among cultivated plants created a major disadvantage for performing plant phenotyping assays, due to the resulting difficulty in determining, in order to measure a variation in a given phenotypic trait, the contribution of selected set environmental conditions and the contribution of the uncontrolled variability of these conditions to the variation of the relevant trait that was detected or measured. For example, this disadvantage encountered with known automatons is illustrated in the examples of this patent application by the difficulty in precisely controlling the hydric conditions for cultivating plants, which creates major variability in the relative humidity conditions experienced by the plants. As is readily understood, this kind of variability under the relative humidity conditions experienced by the plants may result in significant artifacts in the assay's results, e.g., when studying the adaptive response of plants to the application of hydric stress conditions.

In order to eliminate the disadvantages encountered with known automatons, the applicants have developed an automaton device for the cultivation of plants and a method for its use, whose specific characteristics enable each plant that is cultivated and placed on the plate of said automaton to assume, several times consecutively per day, all possible positions on the surface of said plate, in such a way that each plant experiences, several times per day, each of the possible environmental microconditions at each point of the surface of the plate. With the automaton developed by the applicants, all of the cultivated plants experience the same average environmental conditions per 24 hours, and consequently throughout the entire duration of these plants' cultivation.

The device and method for cultivating or phenotyping plants developed according to the invention are described in detail below.

### Automaton for Cultivating or Phenotyping a Plurality of Plants in a Controlled Environment

The goal of this invention is an automaton that can be used to cultivate or phenotype a plurality of plants in a controlled environment, including a plate (10) on which a plurality of movable holders (15) are installed as a cultivation substrate; said movable holders (15) are able to assume, consecutively, all possible positions on the surface of said plate (10); said automaton includes:

(a) a plate (10) that is marked off, respectively, by four sides with raised edges; respectively, a lower edged side (11), a left edged side (12), an upper edged side (13), and a right edged side (14), and whose surface includes:
a row (20) marked off, respectively, by the raised edge (11) of the plate and a guide (21) parallel to said edge (11), with the ends of the guide (21) being far enough away from the edges (12) and (14) of the plate (10) to enable a movable holder (15) to pass through on each side,
a plurality of N adjacent columns (30) C1 through CN perpendicular to the row (20) and marked off by the two raised edges (12, 14) on the two opposite sides of the plate (10) perpendicular to the first side (11) and by a plurality of N−1 guides (31, 32), with the plurality of guides (31, 32) including:
   a first group of (N/2) guides (31) wherein each guide (31) includes two ends (311, 312), with one (311) being in contact with the guide (21), the other (312) being far enough away from the edge (13) of the plate (10) to enable a movable holder (15) to pass through, and
   a second group of (N/2)−1 guides (32) wherein each guide (32), inserted between two successive guides of the first group (31), includes two ends (321, 322), with one (321) being in contact with the edge (13) of the side of the plate (10) opposite the row (20), the other (322) being far enough away from the guide (21) parallel to the row (20) to enable a movable holder to pass through, and
N is an even number,
   (b) a plurality of movable holders (15) installed on the surface of the plate (10),
   (c) means for translating the movable holders (15) along an axis that is parallel to the guides (31, 32), respectively:
a first means (41), located when at rest at the end of the edge (11) that is in contact with the edge (12) of the plate (10), for translating the movable holders (15) in a direction running from the edge (11) towards the edge (13) of the plate (10), along the column C1 marked off by the edge (12) and the adjacent guide (31),
a first series of means (42) for translating the movable holders (15) in a direction running from the guide (21) parallel to the edge (11) towards the edge (13) of the plate (10), along each of the odd-numbered columns C3 through CN−1, and
a second series of means (43) for translating the movable holders (15) in a direction running from the edge (13) towards the edge (11) of the plate (10), along each of the even-numbered columns C2 through CN, and
   (d) means for translating the movable holders (15) along an axis parallel to the row (20), respectively:
a first means (51) located when at rest at the end of the edge (14) that is in contact with the edge (11) of the plate (10), for translating the movable holders (15) in a direction running from the edge (14) towards the edge (12) of the plate (10), along the row (20) marked off by the edge (11) and the adjacent guide (21),
a first series of means (52) for translating the movable holders (15) located on the side of the edge (13) at the end of each of the odd-numbered columns C1 through CN−1, towards the end of each of the even-numbered columns C2 through CN, and
a second series of means (53) for translating the movable holders (15) located on the side of the guide (21) parallel to the edge (11) at the end of each of the even-numbered columns C2 through CN-2, towards the end of each of the adjacent odd-numbered columns C3 through CN−1.

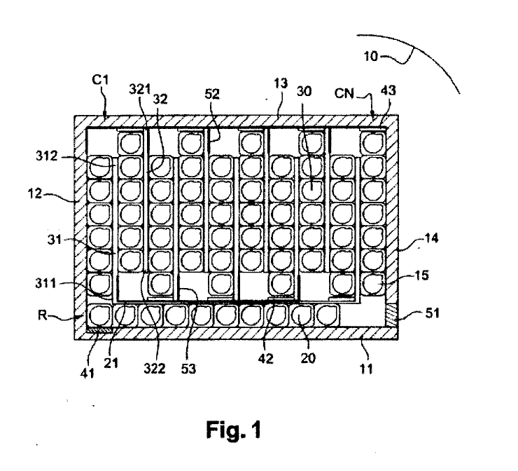

This invention will be more readily understood by referring to the general diagram in FIG. 1, which shows a top view of a specific embodiment of the above defined automaton.

The plate (10), which may also be referred to as a “cultivation plate” in this description, is placed on a table or designed to fit onto a frame. In certain embodiments of the invention, the frame is welded together. It is made of stainless steel and is equipped with six adjustable-height feet (can be raised or lowered by 40 mm) with braces for the feet.

The plate (10) may be of any shape. In every instance, it is important that the four raised-edge sides (11, 12, 13, 14) of the plate (10) mark off a rectangle parallelepiped; that is, either a rectangular-shaped surface or a square-shaped surface. In the preferred embodiments, the plate (10) is square or rectangular in shape.

The plate (10) may be made of a wide range of materials. It should be understood that the material of which the plate is made (10) must not be altered by the environmental conditions applied for plant cultivation or phenotyping, in particular relative humidity conditions. For this reason, the plate (10) is preferably made of a material that is not affected by moisture, such as a polymer material having appropriate mechanical strength, or a metal selected, e.g., from among zinc, aluminum, or stainless steel. Most preferably, the plate (10) is made of aluminum.

Preferentially, the surface of the plate (10) is flat and smooth, enabling easy translation of the movable holders (15) over the entire loop circuit marked off by the sequence including the row (20) followed by the series of adjacent columns (30) C1 through CN. In certain embodiments, rather than being smooth, the surface of the plate (10) includes ball-bearing guidance systems.

The raised edges (11, 12, 13, 14) of the plate (10) need not be of a specific height. Of course, said edges must be high enough to act as guides for the movable holders (15) along the loop circuit marked off by the row (20) and the series of adjacent columns (30) C1 through CN, with little or no risk that the movable holders (15) will run off track or roll over. Moreover, the height of the raised edges (11, 12, 13, 14) of the plate (10) is generally low enough so that it does not interfere with the positioning of the movable holders (15) prior to the automaton's operation. Naturally, the height of the raised edges (11, 12, 13, 14) of the plate (10) may vary considerably from one embodiment to another, in particular depending upon the size of the movable holders (15). By way of illustration, in embodiments of the automaton that are designed for cultivating or phenotyping small plants, e.g., plants having a maximum size of 30 centimeters, the height of the raised edges (11, 12, 13, 14) of the plate (10) may range from 1 to 10 centimeters.

The materials of which the raised edges (11, 12, 13, 14) of the plate (10) are made are of the same type as the materials listed above for the plate (10) since they experience the same environmental stresses. The material of the raised edges (11,12, 13, 14) may be identical to or different from the material of which the plate (10) is made.

The height and material-type characteristics for the guides (31, 32) are similar to the characteristics described above for the edges (11, 12, 13, 14) of the plate (10).

Throughout this description, materials not specifically cited are preferably made of painted aluminum or steel, and the nuts and bolts are generally made of stainless steel.

The movable holders (15) placed on the plate (10) are preferably made of machined polyethylene. They may be of any shape, provided that the combination of their shape and size allows them to be easily translated along the row (20) and the adjacent columns (30) C1 through CN, while preferably maintaining their orientation along the entire loop circuit marked off by the sequence of the row (20) and the adjacent columns (30) C1 through CN. The movable holders (15) are preferably square or rectangular in shape, in order to prevent them from rotating on themselves during their controlled displacement over the surface of the plate (10).

All of the movable holders (15) placed simultaneously on the plate (10) in order to perform a cultivation or phenotyping assay are preferably of the same width. The width of the movable holders (15) is designed so as to enable their translation along the row (20) and along each of the adjacent columns (30) C1 through CN. Hence, the width of the movable holders (15) is both (i) sufficiently smaller than the width of the row (20) and of the adjacent columns (30) C1 through CN to enable them to move along said row and said columns and (ii) sufficiently large such that the translation of the movable holders (15) does not result in a significant misalignment of said holders in relation to the axis of the row (20) and of the adjacent columns (30) C1 through CN, since a misalignment is likely to result in blocking of one or several of the movable holders (15), or even a rotation of at least 90° of one or several of the movable holders (15) in relation to the axis of said row or of said columns.

A major misalignment of a movable holder (15) may represent a disadvantage even in situations where said misalignment does not block the translation of the movable holders (15); more particularly, when the automaton of the invention is being used to phenotype plants. Indeed, in the operational modes for the automaton of the invention wherein one or several phenotypic characteristics are being measured, specifically when an image acquisition step is being performed for each of the tested plants, a misalignment of one or several movable holders (15) between two loop-circuit cycles may lead to the erroneous identification of differences in a given plant from one cycle to another.

The row (20) and each of the adjacent N columns (30) C1 through CN may also be referred to as a “rail” in this description. Said “rails” therefore correspond to the row (20), which may also be referred to as row R, and to the adjacent N columns (30) C1 through CN. The rails are marked off by the four raised-edge sides (11, 12, 13, 14) of the plate (10) and by the inner N guides (21, 31, 32). The displacement area of the movable holders (15) is therefore limited to the surface of the plate (10), where they move in a loop or closed circuit. The width of the row (20) and of each of the adjacent columns (30) C1 through CN is designed such that the movable holders (15) are translated with as little mechanical strength as possible over the entire length of the above defined loop circuit.

As is shown in FIG. 1, the sequence of the row (20) followed by the series of each of the adjacent N columns (30) C1 through CN marks off a loop or closed circuit, along which the movable holders (15) can circulate in guided fashion. A full displacement cycle of a given movable holder (15) is completed when said movable holder (15) has consecutively assumed all of the possible positions along said loop circuit or closed circuit. A subsequent displacement cycle is initiated when said movable holder (15) once again occupies a position identical to the one it had occupied at the start of the previous cycle.

The automaton of the invention is equipped with a plurality of means for translating the movable holders (15), as has already been noted in this description. Said translation means are specifically installed such that their operation, following time sequences to be discussed in greater detail hereinafter, enables each movable holder (15) to assume consecutively all of the possible positions on the surface of the plate (10), and more specifically to assume all of the possible positions along the closed circuit marked off by the sequence of the row (20) and of the adjacent N columns (30) C1 through CN.

As was described previously in the general description of the automaton of the invention, said automaton includes a plurality of means for translating the movable holders (15) on the surface of the plate (10), and more specifically over the entire above-defined loop circuit, respectively:
means for translating the movable holders (15) along an axis that is parallel to the guides (31, 32), and
means for translating the movable holders (15) along an axis that is parallel to the row (20).

These two main types of means for translating the movable holders are described in detail below.

### Means for Translation Along an Axis That is Parallel to the Guides (31, 32)

The means for translation along an axis that is parallel to the guides (31, 32) enable the translation of the movable holders (15), respectively, from a first end (311, 321) towards a second end (312, 322) of each of the adjacent columns (30) C1 through CN, in the general translation direction of the movable holders (15) along the above-defined loop circuit.

Generally speaking, the means for translating the movable holders (15) along an axis that is parallel to the guides (31, 32) include, respectively (i) a first means (41), which can also be referred to as a “left thruster” in reference to FIG. 1, (ii) a first series of means (42), which can also be referred to as “bottom rods” in reference to FIG. 1 and (iii) a second series of means (43), which can also be referred to as “upper rods” in reference to FIG. 1. These three types of means for translation along an axis parallel to the guides (31, 32) are described in greater detail hereinafter.

Hence, the means for translating the movable holders (15) along an axis that is parallel to the guides (31, 32) include, respectively:

a translation means (41), or “left thruster,” located at the end of the row (20) adjacent to the column C1, in contact with the edge (11) of the plate (10), which includes a thrust plane located at the outer end of the thruster directed towards the interior of the plate (10), with the thrust plane's axis being parallel to the edge (11) of the plate (10). In certain embodiments, when the left thruster (41) is in rest position, the thrust plane of said thruster is recessed in relation to the inner wall of the edge (11) of the plate (10). In other embodiments, when the left thruster (41) is in rest position, the thrust plane of said thruster is aligned with the inner wall of the edge (11) of the plate (10). In still other embodiments, when the left thruster (41) is in rest position, the thrust plane can be slightly engaged in the row (20); this results in said thrust plane overlapping with the plane of the inner wall of the edge (11) of the plate (10). In the latter embodiments, the overlapping of the thrust plane of the left thruster (41) is reduced, such that the engagement of said thrust plane in the row (20) does not result in a decrease in width of the row (20) that might interfere with the translation of the movable holders (15). The left thruster (41) is connected to a means enabling displacement of the thrust plane along an axis that is parallel to the axis of column C1.
translation means (42), or “bottom rods,” located at the end of the odd-numbered row columns C3 through CN−1 that is in contact with the guide (21); said bottom rods include a thrust plane that can be translated along an axis that is parallel to the axis of said odd-numbered row columns. The possible locations of the thrust plane of the bottom rods (42) at rest, in relation to the plane of the guide (21), may be similar to those described above for the left thruster (41) in relation to the inner wall of the edge (11).
translation means (43), or “top rods,” located at the end of the even-numbered row columns C2 through CN that is in contact with the edge (13) of the plate (10); said top rods (43) include a thrust plane that can be translated along an axis that is parallel to the axis of said even-numbered row columns. The possible locations of the thrust plane of the top rods (43) at rest, in relation to the inner wall of the edge (13) of the plate (10), may be similar to those described previously for the left thruster (41) in relation to the inner wall of the edge (11).

In certain embodiments of the automaton of the invention, the left thruster (41), the bottom rods (42), and the top rods (43) are actuated, simultaneously or at different times, by executing a full vertical motor revolution, preferably of three vertical motors, respectively:

a first motor for actuating the left thruster (41),

a second motor for actuating the bottom rods (42), and

a third motor for actuating the top rods (43).

Once their movement is completed, these means for translating the movable holders (15) return to their initial rest position, e.g., due to the presence of one or several return springs in the actuation mechanism.

### Means for Translation Along an Axis Parallel to the Row (20)

The means for translation along an axis that is parallel to the row (20) cause the translation of the movable holders (15) along an axis that is perpendicular to the axis of translation of said movable holders (15) triggered by the translation means (41, 42, 43) described above.

Generally speaking, the means for translating the movable holders (15) along an axis that is parallel to the row (20) include, respectively, (i) a first means (51), which can also be referred to as the “return thruster” or “right thruster” in reference to FIG. 1, (ii) a first series of means (52), which can also be referred to as “top arms,” intended to cause the translation of the movable holders (15) in a left-to-right direction in reference to FIG. 1, and (iii) a second series of means (53), which can also be referred to as “bottom arms,” intended to cause the translation of the movable holders (15) in a right-to-left direction in reference to FIG. 1. These three types of means for translation along an axis that is parallel to the row (20) are described in greater detail hereinafter.

Hence, the means for translating the movable holders (15) along an axis that is parallel to the axis of the row (20) include, respectively:

a translation means (51), or “right thruster,” located at the end of the row (20) that is adjacent to the column CN, in contact with the edge (14) of the plate (10). The right thruster (51) includes a thrust plane located at the end of the thruster directed towards the interior of the plate (10), whose axis is parallel to the edge (14) of the plate (10). In certain embodiments, when the right thruster (51) is in rest position, the thrust plane of said thruster is recessed in relation to the inner wall of the edge (14) of the plate (10). In other embodiments, when the right thruster (51) is in rest position, the thrust plane of said thruster is aligned with the inner wall of the edge (14) of the plate (10). In still other embodiments, when the right thruster (51) is in rest position, the thrust plane may be slightly engaged in the row (20); consequently, said thrust plane overlaps with the plane of the inner wall of the edge (14) of the plate (10). In the latter embodiments, the overlap of the thrust plane of the right thruster (51) is reduced, such that the engagement of said thrust plane in the row (20) does not lead to a decrease in width of said row (20) that might interfere with the translation of the movable holders (15). The right thruster (51) is connected to a means enabling the displacement of the thrust plane along an axis that is parallel to the axis of the row (20).
translation means (52) or “top arms,” for displacing movable holders (15) in odd-numbered columns C1 through CN−1 towards the adjacent even-numbered columns C2 through CN. The top arms (52) have a thrust plane whose axis is parallel to the axis of columns C1 through CN; said thrust plane can be translated along an axis that is parallel to the axis of the row (20) or of the edge (13) of the plate (10). The possible locations for the thrust plane of the top arms (52) when at rest, in relation, respectively, to the inner wall of the edge (12) and to the end (321) of the wall of the guides (32), may be similar to those described previously for the right thruster (51) in relation to the inner wall of the edge (14).
translation means (53) or “bottom arms,” for displacing movable holders (15) from even-numbered columns C2 through CN−2 towards the adjacent odd-numbered columns C3 through CN−1. The bottom arms (53) include a thrust plane whose axis is parallel to the axis of columns C1 through CN; said thrust plane can be translated along an axis that is parallel to the axis of the row (20) or of the edge (13) of the plate (10). The possible locations for the thrust plane of the bottom arms (53) while at rest, in relation to the end (311) of the wall of the guides (31), may be similar to those described previously for the right thruster (51) in relation to the inner wall of the edge (14).

In certain embodiments of the automaton of the invention, the right thruster (51), the top arms (52), and the bottom arms (53) are actuated, simultaneously or at different times, by executing a full horizontal motor revolution, preferably of three horizontal motors, respectively:

a first motor for actuating the right thruster (51),

a second motor for actuating the top arms (52), and

a third motor for actuating the bottom arms (53).

Once their movement is completed, these means for translating the movable holders (15) return to their initial rest position, e.g., due to the presence of one or several return springs in the actuation mechanism.

In this description, the distinct terms “left thruster,” “right thruster,” “top rod,” “bottom rod,” “top arm,” and “bottom arm” are used primarily for the sake of clarity in this presentation, in order to highlight the various translation means with which the automaton is equipped. The distinct terms used to distinguish between these various translation means do not necessarily mean that the various translation means differ in their structure.

Therefore, in certain embodiments of the automaton of the invention, all of the translation means are of similar or identical structure. In other embodiments of the invention, the translation means may be partially identical to each other. For example, in certain embodiments of the automaton, the translation means designated by an identical term above are of identical structure to each other. In still other embodiments of the automaton of the invention, each of the means for translating the movable holders (15) has its own structure, with each individual translation means being structurally distinct from each of the others.

The translation means with which the automaton of the invention is equipped are made of a material whose mechanical strength and resistance to environmental conditions are appropriate; the type of material can be readily selected by the expert based on his/her general knowledge. In certain embodiments of the automaton, the translation means are made of metal, e.g., of aluminum or stainless steel, preferably stainless steel.

In certain embodiments, the bottom (42) and top (43) rods are of the pivot rod type, articulated on an axis made of calibrated stainless steel and assembled onto a spring tab. In certain embodiments, the top (52) and bottom (53) arms are arms with spot-welded paddles, mounted onto a ball screw pad, e.g., onto KUE 15-type INA ball screw pads.

The control mechanisms for displacing the movable holders (15) are preferably placed underneath the plate (10).

The automaton of the invention is very compact, which is due to the fact that almost all of the surface area of the plate (10) can be occupied by the movable holders (15), with the small remaining surface area of the plate (10) being occupied by the guides (21, 31, 32). The specific combination of the above described characteristics of the automaton of the invention makes it possible to install and move numerous movable holders (15) on a small surface. Moreover, the value of the surface of the plate (10) of the automaton of the invention can be easily determined or adapted by the expert based on the size of the movable holders (15) used, along with their number. In certain embodiments of the automaton of the invention, at least 100, better still at least 500, movable holders (15) are arranged on the surface of the plate (10). However, the dimensions of the surface of the plate (10) can be customized in order to use the automaton of the invention with fewer than 100 movable holders (15).

Based on the illustration in FIG. 1, the expert readily understands that a minimum number of movable holders (15) must be placed on the surface of the plate (10) in order to enable effective translation of the holders during each actuation step of the translation means defined previously and to enable the circulation of each movable holder (15) over the entire loop circuit in as brief a time period as possible, such that each of the movable holders (15) can assume consecutively all of the possible positions along said loop circuit in as brief a time period as possible.

While the automaton is intended to be used for cultivating or phenotyping a plurality of plants, it is not mandatory for each movable holder (15) that is present on the surface of the plate (10) to contain a plant. By definition, each movable holder (15) containing a plant also contains a cultivation substrate adapted to said plant. Hence, the movable holders (15) that contain a plant hold a cultivation substrate in which a plant has been planted. The cultivation substrate can optionally be placed inside a container, which in turn is placed inside a movable holder (15). By cultivation substrate, or clod, we mean any substrate that enables cultivation of a plant and that is designed to grow the latter under selected conditions. Depending upon the plant species to be cultivated and the desired growing conditions, the expert can determine the adapted cultivation substrate in advance based on his/her general knowledge of the field. Preferably, cultivation substrates holding plants are placed in at least some of the movable holders (15). When the automaton of the invention is used for phenotyping plants, cultivation substrates holding plants are preferably placed on all of the movable holders (15). Logically, the more plants that are present on the plate (10), the more reliable the statistical analysis of the phenotypic characteristics of the tested plants will be. Therefore, preferably, each movable holder (15) placed on the plate (10) of the automaton holds a cultivation substrate and a plant.

When the plants are circulating on the surface of the plate (10), it may prove useful to follow the change in weight of each of them at each completed displacement loop or cycle. This type of operation requires weighing of each movable holder (15) at least once during each cycle, e.g., using a customized scale. The automaton can therefore be equipped with at least one means for weighing a movable holder (15), e.g., an IP65 SCAIME load cell measuring 102 mm×22 mm×16 mm. The weighing means are generally directly underneath the surface of the plate (10), under the movable holders (15). The weighing means can be placed anywhere along the loop circuit of the movable holders (15), preferably in an angle, so that a measurement can be taken without being interfered with by any movable holders (15) that may be too close by.

According to another aspect, it is important to provide the plants with a controlled water supply. Likewise, it is important to provide the plants with a controlled fertilizer solution supply. While it can be provided in any form, e.g., in granules, the fertilizer solution is preferably provided in liquid form, if necessary along with the water supply. The volume of water and/or of fertilizer solution provided can be selected by the investigator.

Thus, in certain embodiments, the automaton of the invention is equipped with at least one means for providing water or fertilizer solution to the cultivation substrates holding the plants placed in the movable holders (15). In these embodiments, the automaton can have one or several means for providing water only, one or several means for providing fertilizer solution only, or one or several means for simultaneously providing water and fertilizer solution.

Advantageously, said means for providing water or fertilizer solution is located directly below the means for weighing the movable holders (15). Indeed, in these types of embodiments, it is possible to measure the quantity of water and/or of fertilizer solution precisely provided to the cultivation substrate of a plant located on top of a scale. Depending upon the selected water and/or fertilizer solution distribution means, such as a membrane pump or a peristaltic pump, the precision of the provided solution volume will not be the same, and weighing enables a posteriori verification of the provided quantity of water and/or fertilizer solution. This makes it possible, if necessary, to supplement this distribution by providing an additional volume of water or fertilizer solution.

When the automaton of the invention is used for phenotypic analysis of plants, it is additionally equipped with at least one means for measuring a phenotypic characteristic of a plant. Preferably, said measurement means consists in an image acquisition device, also referred to as a camera device. This may be, e.g., a photographic apparatus or a digital camera. But it may also be any other type of sensor that enables, e.g., measurement of visible and/or infrared radiation, chlorophyll fluorescence, or any other instrument able to take a phenotypic measurement. In certain embodiments, the measurement means has a holder, which is preferably made of stainless steel and attached to the frame of the table.

It is possible to consider placing a plurality of other measurement or detection devices on the plate (10) of the automaton or in its immediate periphery. For example, the automaton can be equipped with a bar code reader. When a bar code is placed on each of the movable holders (15), the presence of a bar code reader device in the automaton makes it possible to identify each plant and to know the degree of completion of a given displacement cycle of the movable holders (15). The automaton can also be equipped with any other means for specifically identifying each movable holder (15), including radiofrequency identification devices.

As was mentioned previously, the expert will readily understand that the dimensions of the automaton of the invention can vary considerably:
depending upon the size of the plants to be cultivated; that is, depending upon the size of the movable holders (15) onto which the cultivation substrates holding plants must be placed, and
depending upon the number of movable holders (15) that must be placed on the surface of the plate (10).

Depending upon the size, and consequently the weight, of the movable holders (15) on which the cultivation substrate and the plants are placed, the power needed for the thrusting means to translate the movable holders (15) is customized. When it is equipped with thrusting means with customized power and mechanical strength, the automaton of the invention can be used to cultivate or phenotype large plants, including shrubs and young trees, e.g., trees less than five years old. However, in general, the automaton of the invention is primarily intended for cultivating or phenotyping plants that are of average size, 1.5 meters high at most and easy to move.

### Facility for Cultivating or Phenotyping a Plurality of Plants in a Controlled Environment

A specific embodiment of a cultivation or phenotyping facility of the invention is illustrated in FIG. 6 and is discussed in greater detail hereinafter. In the specific embodiment of the facility illustrated in FIG. 6, no movable holder (15) was placed on the plate (10).

As is shown in the diagram in FIG. 6, this embodiment of a cultivation or phenotyping facility includes:
a cultivation or phenotyping automaton as defined previously in this description; said automaton including:
   a motor (141) for actuating the left thruster (41),
   a motor (142) for actuating the bottom rods (42),
   a motor (143) for actuating the top rods (43),
   a motor (151) for actuating the right thruster (51),
   a motor (152) for actuating the top arms (52),
   a motor (153) for actuating the bottom arms (53),
   a means (110) for weighing the movable holders (15),
   a means (120) for supplying water or fertilizer solution needed for plant growth
   a means (130) for acquiring images of the plants placed on the movable holders (15),
control and command means (160) for each of the motors (141, 142, 143, 151, 152, 153) with which the automaton is equipped,
a control and command means (170) for the means (110) for weighing the movable holders (15),
a control and command means (180) for the means (120) for providing water or fertilizer solution,
a control and command means (190) for the image acquisition means (130), and
a digital calculator (100) connected to each of the above described control and command means (160, 170, 180, 190), and whose memory is loaded with a set of instructions for the coordinated operation of said control and command means (160, 170, 180, 190).

As is shown in the diagram in FIG. 7, in certain specific embodiments of the facility of the invention, a weighing means (110), a water and/or fertilizer solution delivery means (120), and an image acquisition means (130) can be concentrated in a single location on the plant displacement circuit, e.g., at the location marked off by the edges (13, 14) of the plate (10).

As was described previously, the means (41, 42, 43, 51, 52, 53) for translating the movable holders (15) of the automaton are preferably actuated by a total of six motors (141, 142, 143, 151, 152, 153). These motors may be identical to or different from each other, or some of them may be identical to each other and the others may be different from the latter. For the automaton to operate properly, these motors must be coordinated and therefore precisely controlled. This involves connecting the automaton to at least one control and command means (16) for the motors (141, 142, 143, 151, 152, 153) actuating the means (41, 42, 43, 51, 52, 53) for translating the movable holder (15).

Therefore, this invention also relates to a facility that can be used for cultivating or phenotyping a plurality of plants in a controlled environment, including an automaton as described previously and at least one control and command means (160) for the means (41, 42, 43, 51, 52, 53) for translating the movable holders (15). In the embodiment of the facility shown in FIG. 6, a single control and command means (160) for translating the movable holders (15) is used for commanding and controlling all of the six motors (141, 142, 143, 151, 152, 153) in a coordinated way.

As is shown in FIG. 6, each of the motors (142, 143, 152, 153) simultaneously drives the movement, respectively, of the bottom rods (42), the top rods (43), the top arms (52), and the bottom arms (53). Transmission of the movement of each of said motors (142, 143, 152, 153) towards the above-mentioned translation means (42, 43, 52, 53) can be performed using a drive shaft that is mechanically connected, either directly or via speed reducing gears, to the motor's output gear. The drive shaft is itself mechanically connected to the mechanism for actuating the corresponding translation means (42, 43, 52, 53). For example, the drive shaft that is mechanically connected upstream of the output gear of the motor (142) is connected downstream to the mechanism for actuating each of the bottom rods (42). In this specific embodiment, each of the means (42, 43, 52, 53) for translating the movable holders (15) is connected to the corresponding drive shaft by a series of gears or cams. For example, the drive shaft includes a gear or cam pinion connected to the relevant mechanism for driving each of the means (42, 43, 52, 53) for translating the movable holders (15). By way of illustration, with reference to FIG. 6, and while not shown in detail in said FIG. 6, the drive shaft that is mechanically connected to the motor (142) includes a gear or cam pinion located opposite, along an axis that is parallel to the axis of columns C1 through CN of the plate (10), the mechanism for actuating each of the bottom rods (42). The translation means (42, 43, 52, 53) can be actuated by a system of cams and a return spring. By way of illustration, the drive shaft that is mechanically connected to the motor (142) includes, opposite each of the bottom rods (42), a cam wheel integrated into said drive shaft, with the outer edge of the cam wheel being in permanent contact with a rod connected to the thrust plane of the corresponding bottom rod (42); said connecting rod is perpendicular to the thrust plane. Moreover, the bottom rods (42) are connected to a return spring that keeps them in a rest position when no mechanical stress is present. In this embodiment, one revolution of a full turn of the drive shaft, and therefore also of the cam wheel, causes, (i) during the first half-turn of the cam wheel, the translation of each bottom rod (42) and its becoming engaged in, respectively, each of the columns C3 through CN−1, then (ii) during the second half-turn of the cam wheel, the return of each bottom rod (42) towards the initial rest position, via the action of the return spring. The description of the above embodiment, in relation with the mechanism for actuating the bottom rods (42), may be extended to the mechanism for actuating all of the means (41, 42, 43, 51, 52, 53) for translating the movable holders (15) with which the automaton of the invention is equipped.

Preferentially, the motors (141, 142, 143, 151, 152, 153) consist in electric “stepper” motors; that is, motors that transform an electrical impulse into mechanical energy enabling angular displacement of the rotor, referred to as a “step,” with which the expert is highly familiar. Stepper motors encompass permanent magnet motors, variable reluctance motors, and mixed motors consisting in reluctance variable motors whose rotor is magnetized.

In certain preferred embodiments, (a)synchronous motors with a reducer and movement sensors are used. The (a)synchronous motors with a reducer may be geared motors, e.g., the Oriental Motor 5RK60RGU PWE plus 5GU60KV (with a 1/180 ratio) plus an ES02 speed gear, supplied with 230-volt alternating current, 60 watt power, with a frequency converter for controlling the speed along with accelerations and braking. The motor/thruster connection can be provided by a tie-rod-and-ball-joint system, preferably equipped with a spring tab in order to counteract any possible height variations on the movable holders (15), and the reducer output displacement controls can be of the rod/crank type. As for the movement sensors or “limit sensors,” these may be induction sensors, e.g. IFM-type sensors, with an M12 or M8 connector, for transmitting data on the most distant positions of the movable holders (15). They are preferably actuated by the thrusters' control rods, located under the plate (10).

Broadly speaking, the means for translating the movable holders (15) are controlled via a digital calculator (100), which can also be referred to as a “supervisory computer.”

In the embodiment of the facility for cultivating or phenotyping plants illustrated in FIG. 6, the digital calculator (100) includes a central unit (101) equipped with at least one digital processor and at least one data storage means. The central unit (101) is connected to a data display device (102) and to a data entry device (103). In FIG. 6, the digital calculator (100) also includes a tracking device (104), which can be connected directly to the central unit (101), or indirectly to the central unit (101) via the data entry device (103).

The digital calculator (100) is connected to the various control and command means (160, 170, 180, 190). In the embodiment shown in FIG. 6, the control and command means (160, 170, 180, 190) consist in electronic cards that are housed inside the box for the central unit (101). In other embodiments of the facility of the invention, one, several, or all of the control and command means (160, 170, 180, 190) are physically separated from the central unit (101) and are connected to it by appropriate connection means, generally by customized electrical cables. In certain embodiments of the facility of the invention, the control and command means (160, 170, 180, 190) are physically grouped together on a single electronic card, or on a number of electronic cards that is smaller than the number of control and command means (160, 170, 180, 190).

Preferably, the automaton is additionally equipped with at least one means (110) for weighing the movable holders (15), and with at least one means (120) for supplying water or fertilizer solution.

Preferentially, as is shown in FIG. 7, the water and fertilizer solution supply means (120) are located plumb with a means (110) for weighing the movable holders (15), as previously described. This specific position of the water or fertilizer solution supply means (120), in relation to the weighing means (110) makes it possible, when cultivating or phenotyping plants, to perform a step for monitoring the volume of water or fertilizer solution supplied to each plant in relation to a predetermined reference value. In these embodiments, said facility includes at least one control and command means (170) connected to said weighing means (110) and at least one control and command means (180) connected to said water or fertilizer solution supply means (120), enabling adjustment of the quantity of water or fertilizer solution supplied depending upon the weight of the measured movable holder (15).

Said weighing means (110) and said water or fertilizer solution supply means (120) are controlled and commanded by the above described supervisory computer (100), to which they are connected via electrical and or electronic connection means.

In the embodiment of the facility shown in FIG. 6, the water or fertilizer solution supply means (120) includes a water supply means (121) and a fertilizer solution supply means (122) necessary for plant growth. Each of these means (121, 122) includes a pump device that is, in the flow direction of the fluids, in fluidic communication (i) with a water or fertilizer solution supply device, located upstream, and (ii) with a single nozzle for distributing a water/fertilizer solution mixture, located downstream. Hence, in the embodiment in FIG. 6, a single outlet nozzle delivers both water and fertilizer solution. This also encompasses any other embodiment within the expert's scope of knowledge, including means (121) and (122) including separate outlet nozzles.

As has already been indicated, the pumps with which the means (121, 122) are equipped may consist in known peristaltic pumps. Using peristaltic pumps enables precise control of the pumped and delivered volume of liquid. When the facility is operating, at least one data storage means of the digital calculator (100) is loaded with a computer program that contains a set of instructions, including instructions that enable the automaton to adjust the quantity of water and/or fertilizer solution being delivered based on the weight of the movable holder (15) that has been measured.

A check weighing, performed after the distribution of water or fertilizer solution, makes it possible to know precisely the amount of water and/or fertilizer solution that was initially delivered, and if necessary to make up for a distribution that is insufficient in relation to the predetermined reference values applied by the control and command means. The measured weight can be displayed directly on the weighing means' (110) display or on the display device (102) of the digital calculator (100). Display devices can also be located on a console placed near the automaton.

In certain embodiments of the facility, the automaton is additionally equipped with at least one means for measuring a phenotypic characteristic of a plant, as described previously. In these embodiments, said facility includes at least one means for controlling and commanding said measurement means and at least one means for storing the data generated by said measurement means.

Generally, the controlling of each means for measuring a phenotypic plant characteristic is performed by the supervisory computer (100), which is connected to any phenotypic characteristic measurement means by electrical and/or electronic connection means. The storage of data generated by each measurement means is also performed by the supervisory computer (100).

In the embodiment of the facility for cultivating or phenotyping plants shown in FIG. 6, one of the means for measuring a phenotypic plant characteristic consists in an image acquisition means (130). Preferentially, this is a digital device for taking images, such as a digital photographic apparatus or a digital camera, equipped with a digital sensor of any type, e.g., the CCD (for “Charge Couple Device”) or the CMOS (for “Complementary Metal Oxide Semi-Conductor”) type. As is shown in FIG. 7, the latter may be located plumb with the weighing means (110) and the water and/or fertilizer solution delivery means (120).

The image acquisition means (130) is connected to the control and command means (190); the latter is in turn connected to the central unit (101) of the digital calculator (100). The digital image data can be, at least temporarily, preserved inside a data storage means included inside the image acquisition device (130) or inside the control and command means (190) to which it is connected. However, in order to measure a phenotypic plant characteristic, the digital image data are transferred, at least temporarily, into a data storage means in the digital calculator (100) in order to be properly processed.

In general, in order to measure at least one phenotypic plant characteristic based on data contained in a digital image file, the memory of the digital calculator (100) is loaded with a computer program containing a set of image analysis instructions. By executing this type of computer program starting with digital plant image data, at least one phenotypic characteristic of the photographed or filmed plant is measured, such as (i) the height and/or width of the plant; (ii) the leaf surface area, (iii) the stem, leaf, or flower color; (iv) the plant's general architecture, including the angle of the leaves in relation to the stem, to the branch, or to the trunk, or (v) a biomass measurement. In order to measure at least one phenotypic plant characteristic, one may use a known digital processing program, e.g., a computer program selected from the ones described in PCT International Patent Application No. WO 90/14635, in European Patent No. EP 1,154,370, in U.S. Pat. Nos. 5,841,883, 5,206,918, and 5,253,302, or in the article authored by Granier et al. (2006, New Phytologist, Vol. 169: 623-635). An example image of the leaf surface area of a plant that can be extracted from a digital photo that undergoes automatic image analysis by a computer program of this type is shown in FIG. 8.

In certain embodiments, the data generated by image acquisition make it possible, after these data are processed by an appropriate computer program, to determine whether the movable holder (15) placed inside the lens field of view of the image acquisition device is holding a plant or not. This may keep the user from having to enter in advance, into the supervisory computer (100), data relating to the presence or absence of a plant based on the movable holder (15) under consideration. However, this selection system is only valid when any plant present in the movable holders (15) has a non-null leaf surface area.

The image analysis data and/or the measurement values of at least one phenotypic plant characteristic are stored in the memory of the digital calculator (100). Once stored, these values can be used in calculations for evaluating cultivation or phenotyping assay results.

One implementation mode for the above facility is described in Example 2.

For optimal use of the automaton, it is desirable, even necessary for phenotypic analysis, for the physical conditions of the environment in which the automaton is placed to be able to be set and controlled thereafter. In this case, the automaton is placed inside a plant cultivation enclosure, and said facility additionally includes at least one means for controlling and commanding at least one physical condition of the environment inside which the automaton is placed.

By “cultivation enclosure,” we mean, in the sense of this invention, any enclosed site inside which plants can be cultivated; this may be, for example, a grow box, a cultivation module, a cultivation chamber, or a grow room such as those used in a lab setting, with the volume of said cultivation enclosure being customized to contain the automaton. Optimally, the size of the cultivation enclosure is customized to accommodate the automaton's size.

Said physical condition of the environment in which the automaton is placed that is controlled and commanded is generally selected from relative humidity, lighting, and temperature levels, but it is also possible to control the atmospheric pressure of the environment in which the automaton is located, or any other physical parameter likely to influence plant growth.

Control is performed by sensors that are present near the automaton. Command is performed by apparatuses such as an air conditioner, a humidifier, a pressurization system, a lighting system, etc. Preferably, the sensors are directly linked via electrical and/or electronic means to said apparatuses, which are preset and able to adapt their response based on the data measured by the sensors. However, the data may also pass through the supervisory computer (100) to which said sensors and apparatuses are connected via electrical and/or electronic means; the supervisory computer is responsible for controlling said apparatuses based on the data measured by said sensors, using commands established in advance by the user.

When one or several other possible devices are placed on the plate (10) of the automaton or at its edge, e.g., a bar code reader, then said facility would additionally include at least one control and command means for this device or these devices.

Preferentially, the wiring under the plate (10) is bundled on a terminal block inside a box; and the facility is equipped with an emergency stop, preferably of push-button type, that is accessible on the top of the plate (10). Preferentially, the facility includes a painted steel cabinet, e.g., of the Eldon brand, measuring 1200 mm×1200 mm×400 mm, which includes at least one disconnect switch, a 24-volt power supply, a 400/230-volt 630 VA transformer and its protections, seven outgoing cables for the motors, a weight protection, a differential circuit breaker, a Piltz-type autocontrol unit for the emergency stop and its relays, panel lights, and push buttons. In certain embodiments, the facility is managed by a Micrologix 1500-type automaton.

### Method for Cultivating or Phenotyping a Plurality of Plants in a Controlled Environment

This invention also relates to a method for cultivating or phenotyping a plurality of plants in a controlled environment, wherein each of the plants to be cultivated is held by a cultivation substrate placed inside a movable holder (15) on the surface of a plate (10) whose surface is divided, respectively, into:

a row R located along a first edge (11) of the plate (10) that has two opposite ends,
a plurality of N adjacent columns (30) C1 through CN, perpendicular to the row R, with each of the columns having two opposite ends,
with the first column C1 communicating, at its first end, via an opening large enough for the movable holders (15) to pass through, with the first end of the row R, and, at its other end, via an opening large enough for the movable holders (15) to pass through, with the following adjacent column C2,
with the Nth CN column communicating, at its first end, via an opening large enough for the movable holders (15) to pass through, with the opposite end of the row R, and, at its other end, via an opening large enough for the movable holders (15) to pass through, with the preceding adjacent column CN−1,
with each of the remaining columns C2 through CN−1 communicating,
   at one of its ends, via an opening large enough for the movable holders (15) to pass through, with a preceding adjacent column, and
   at its other end, via an opening large enough for the movable holders (15) to pass through, with a following adjacent column,
      with each movable holder (15) being able to assume, consecutively, all of the possible positions on the surface of said plate (10), respectively:
any position R1 through RA within said row R located along said first edge (11) of the plate (10), with A being equal to the maximum value of the number of movable holders (15) likely to be contained in said row R,
any position CX1 through CXB within a column CX, with X consisting in a whole number ranging from 1 to N, with N being an even number, and B being equal to the maximum value of the number of movable holders (15) likely to be contained in a column CX,
   with said method including the steps consisting in:
a) initializing a displacement cycle of the movable holders (15) by positioning the latter on the surface of the plate (10) in such a way that the movable holders (15) are placed so as to enable any vertical translation and/or any horizontal translation during the subsequent step,
b) performing a step involving vertical translation of a subset of the movable holders (15) along the axis of the columns C1 through CN, with said step including:
b1) a translation T1 of the movable holders (15) contained in the even-numbered columns C2 through CN towards the row R, and
b2) a translation T2 of the movable holders (15) contained in the odd-numbered columns C1 through CN−1 in the direction that is opposite the translation direction T1,
   with the understanding that steps b1) and b2) can be performed simultaneously or separately, since the order in which steps b1) and b2) are performed is irrelevant,
c) performing a step involving horizontal translation of a subset of the movable holders (15) along the axis of the row R, with said step including:
c1) a translation T3 of the movable holders (15) contained in the row R in the direction of the horizontal axis passing consecutively through columns CN through C1,
c2) a translation T4 of the movable holders (15) located at the end opposite the row R of each of the columns C1 through CN−1 in a direction along the axis passing consecutively through columns C1 through CN, and
c3) a translation T5 of the movable holders (15) located at the other end of each of the columns C2 through CN−2 in a direction along the axis passing consecutively through columns C1 through CN,
   with the understanding that steps c1), c2) and c3) can be performed simultaneously or separately, since the order in which steps c1), c2) and c3) are performed is irrelevant, and with it also being understood that steps b) and c) are can be performed separately, since the order in which steps b) and c) are performed is irrelevant,
d) repeating steps b) and c) a sufficient number of times for each of the movable holders (15) to have assumed, at the end of the last repetition cycle of steps b) and c) consecutively, all of the possible positions on the surface of said plate (10), such that a full displacement cycle of the movable holders (15) has been performed,
e) repeating step d) for a sufficient number of cycles to cultivate the plurality of plants.

The above method is preferentially performed with the previously-described automaton or facility. The various steps of the above method are described in detail below.

### Step a): Method Initialization

Generally, step a) consists in a method initialization step, at the end of which the movable holders (15) are positioned on the surface of the plate (10). Preferentially, the movable holders (15) are placed in step a) in such a way that the enable any kind of subsequent translation, either vertical (step b)) or horizontal (step c)).

The translation performed in step b) is referred to as “vertical” in reference to the direction in which FIG. 1 is read. The translation performed in step c) is referred to as “horizontal” in reference to the direction in which FIG. 1 is read. Obviously, FIG. 1 shows a top view of the automaton of the invention, such that, given the fact that the surface of the plate (10) is actually in a horizontal plane, the “vertical” and “horizontal” translations are, when the automaton is actually operating, simply perpendicular to each other.

The circulation of the movable holders (15) on the plate (10) is ensured by the previously-described translation means; namely, on the one hand, the left thruster (41) and the bottom (42) and top (43) rods, actuated simultaneously or separately, and, on the other hand, the right thruster (51) and the top (52) and bottom (53) arms, actuated simultaneously or separately. By “vertical” translation, we mean any translation resulting from setting in motion the translation means (41, 42, 43) for the movable holders (15). By “horizontal” translation, we mean any translation resulting from setting in motion the translation means (51, 52, 53) for the movable holders (15).

In certain embodiments of the method, at least some of the vertical translation means and horizontal translation means for the movable holders (15) can be set in motion simultaneously. However, in real-world practice, this is difficult to implement because controlling the proper synchronization of the translation means is a complex task.

In fact, for proper circulation of the movable holders (15), all of the displacements in a given direction must be concluded before any displacement can be performed in the perpendicular direction. This means that before setting in motion a vertical translation means, one will preferably wait until each of the horizontal translation means has been actuated, and vice versa, before setting in motion a horizontal translation means, one will preferably wait until each of the vertical translation means has been actuated.

If the movable holders (15) are initially positioned in an arbitrary fashion on the surface of the plate (10) of the automaton, in order to enable any translation in the subsequent step, whether vertical (step b) or horizontal (step c), the movable holders (15) must be suitably placed before the subsequent translation step can be performed.

The suitable placement of the movable holders (15) in step a) can be performed manually or by actuating, in appropriate fashion, the various translation means (41, 42, 43, 51, 52, 53) described previously in this description, preferably manually.

We record as B the maximum value of the number of movable holders (15) likely to be contained in any given CX column, with X being a whole number ranging from 1 to N. We record as A the maximum value of the number of movable holders (15) likely to be contained in the row R, which corresponds to the row (20) of the automaton.

In order to initialize a displacement cycle of the movable holders (15), in an optimal embodiment of the method, the movable holders (15) must be placed on the surface of the plate (10) of the automaton according to mandatory minimum conditions.

For any horizontal translation to be possible, the row R must include at least one empty space, located in any position within said row R; additionally, the row R must include a maximum number of movable holders (15) equal to A−1; each pair of upper movable holder spaces (in reference to FIG. 1) of two adjacent columns C1-C2, C3-C4, etc. must include at least one empty space, and each pair of lower movable holder spaces (in reference to FIG. 1) of two adjacent columns C2-C3, C4-C5, etc. must include at least one empty space. When the movable holders (15) are positioned on the surface of the plate (10) as described above at the end of Step a), the expert readily understands that the displacement of the movable holders (15) can be optimally performed because the motion of the translation means (51, 52, 53) is never interfered with.

Likewise, for any vertical translation to be possible, each column C1 through CN must include at least one empty space, located in any position within each of said columns; the row R, however, can be full. Hence, the row R must include a maximum number of movable holders (15) that is equal to A, and each column must include a maximal number of movable holders (15) that is equal to B−1. When the movable holders (15) are positioned on the surface of the plate (10) as described above at the end of Step a), the expert readily understands that the displacement of the movable holders (15) can be optimally performed because the motion of the translation means (41, 42, 43) is never interfered with.

Lastly, for any horizontal translation and any vertical translation to be possible at the same time, the initial conditions presented above must be combined relative to the filling rate of the row R and of the adjacent columns (30) C1 through CN. When the movable holders are positioned on the surface of the plate (10) as described above at the end of Step a), the expert readily understands that the displacement of the movable holders (15) can be optimally performed because the motion of the translation means (41, 42, 43, 51, 52, 53) is never interfered with.

Once the movable holders (15) are positioned, at the end of initialization Step a), the automaton is ready to start the first cycle for circulating the movable holders (15) along the loop circuit defined previously in this description.

As was presented previously, the plate (10) of the automaton can have a number of movable holders (15) that is lower than the maximum permitted number of movable holders (15); however, one must make sure that the number of movable holders (15) present on the plate (10) of the automaton is sufficient for each of them to perform a full displacement cycle. However, the automaton's operation is optimal when the plate (10) of the automaton has the maximum permitted number of movable holders (15). Therefore, the operator is advised to place the maximum permitted number of movable holders (15) on the plate (10) of the automaton, even if some movable holders (15) are empty.

Generally, the combined implementation, consecutively over time, of the two translation steps b) and c), whether this involves “vertical” translation step b) followed by “horizontal” translation step c), or “horizontal” translation step c) followed by “vertical” translation step c), causes the displacement of all of the movable holders (15) by one step. Each movable holder (15) then moves from a position Z to a position Z, Z+1, or Z+2, depending upon the relevant movable holder (15) and its location in relation to any empty spots, with Z being a whole number equal to all of the possible positions of a movable holder (15) on the surface of the plate (10), and more specifically to all of the possible positions of a movable holder (15) along the loop circuit marked off by the sequence of the row R and the series of adjacent columns (30) C1 through CN.

### Vertical Translation Step b) of the Method

In step b), a vertical translation is performed of the movable holders (15) that are already engaged, at the beginning of this step, in any of columns C1 through CN, and of the movable holder that is located, at the beginning of this step, at the end of the row R adjacent to column C1. A vertical translation step b) enables displacement of the movable holders (15) by one-half step.

Given the geometry of the part of the loop circuit that is marked off by the sequence of the row R and the series of adjacent columns C1 through CN, advancing the movable holders (15) from a position Z to a position Z or Z+1 requires:
a first “vertical” translation, also referred to as translation “T1,” of the movable holders (15) contained in the even-numbered columns C2 through CN, in the direction running from the end of these columns located on the side of the edge (13) of the plate (10) towards the end located on the side of the edge (11) of the plate (10), and
a second “vertical” translation, also referred to as translation “T2,” of the movable holders (15) contained in the odd-numbered columns C1 through CN−1 and of the movable holder located at the end of the row R adjacent to column C1, in the direction running from the end of these columns located on the side of the edge (11) of the plate (10) towards the end located on the side of the edge (13) of the plate (10).

In step b), the T1 and T2 translations can be performed simultaneously or at different times. In the preferred embodiments of the method, the T1 and T2 translations are performed simultaneously in order to decrease the duration of vertical translation Step b).

By definition, the more the duration of vertical translation step b) is decreased, the higher the average translation speed of the movable holders (15) along the loop circuit is, and the more the duration of a full cycle for translating a given movable holder (15) is also decreased. And also by definition, the more the duration of a full cycle for translating a movable holder (15) is decreased, the more possible it is to execute a large number of full translation cycles per given time period, which encourages the application of homogeneous average environmental conditions to the plants held by the movable holders (15).

However, there may be a threshold, in terms of the number full translation cycles per 24 hours, beyond which the result differences will no longer be detectable. This means that it is possible to perform a relatively limited number of cycles for the same result in terms of homogeneity of plant cultivation conditions.

In order to execute step b1) of translation T1, one actuates, simultaneously or at different times:
the translation means (43), or top rods, that equip each of the even-numbered columns C2 through CN, and whose thrust plane is translated along an axis that is parallel to the axis of columns C1 through CN, in a direction running from the edge (13) towards the edge (11) of the plate (10). The course of the translational movement of the top rods (43) is customized in order to cause the translation of the movable holder (15) located opposite its thrust plane, from a position Z to a position Z+1.
   In order to execute step b2) of translation T2, one actuates, simultaneously or at different times, respectively:
the translation means (41), or left thruster, located at the end of the row R adjacent to column C1, and whose thrust plane is translated along an axis that is parallel to the axis of the columns C1 through CN, in a direction running from the edge (11) towards the edge (13) of the plate (10). The course of the translational movement of the left thruster (41) is customized in order to cause the translation of the movable holder (15) located opposite its thrust plane, from a position Z to a position Z+1.
The translation means (42), or bottom rods, that equip each of the odd-numbered columns C3 through CN−1, and whose thrust plane is translated along an axis that is parallel to the axis of the columns C1 through CN, in a direction running from the edge (11) towards the edge (13) of the plate (10). The course of the translational movement of the bottom rods (42) is customized in order to cause the translation of the movable holder (15) located opposite its thrust plane, from a position Z to a position Z+1.

As has already been indicated, steps b1) and b2) can be performed simultaneously or at different times. However, steps b1) and b2) are preferably executed simultaneously in order to decrease the total duration of step b). In the embodiments of the method wherein steps b1) and b2) are performed at different times, the order in which steps b1) and b2) are executed is irrelevant.

### Horizontal Translation Step c) of the Method

In step c), one performs a horizontal translation of the movable holders (15) that are already engaged, at the beginning of this step, in the row R, at the end of each of the columns C1 through CN−1 that is located on the side of the edge (13) of the plate (10), and at the end of each of the columns C2 through CN−2 that is located on the side of the edge (11) of the plate (10). A horizontal translation step c) enables displacement of the movable holders (15) by one-half step.

Given the geometry of the part of the loop circuit that is marked off by the sequence of the row R and the series of adjacent columns C1 through CN, advancing the movable holders (15) from a position Z to a position Z or Z+1 requires:
a first “horizontal” translation, also referred to as translation “T3,” of the movable holders (15) contained in the row R, in the direction running from the end of the row R located on the side of the edge (14) of the plate (10) towards the end of the row R located on the side of the edge (12) of the plate (10),
a second “horizontal” translation, also referred to as translation “T4,” of the movable holders (15) contained in each of the odd-numbered columns C1 through CN−1, in the direction running from the edge (12) to the edge (14) of the plate (10), and
a third “horizontal” translation, also referred to as translation “T5,” of the movable holders (15) contained in each of the even-numbered columns C2 through CN−2, in the direction running from the edge (12) to the edge (14) of the plate (10).

In Step c), the T3, T4, and T5 translations can be performed (i) all at the same time, (ii) two steps simultaneously and a third step separate from the two others, or (iii) all three steps at different times. In the preferred embodiments of the method, the T3, T4, and T5 translations are performed simultaneously in order to decrease the duration of horizontal translation Step c).

By definition, the more the duration of horizontal translation step c) is decreased, the higher the average translation speed of the movable holders (15) along the loop circuit is, and the more the duration of a full cycle for translating a given movable holder (15) is also decreased. And also by definition, the more the duration of a full cycle for translating a movable holder (15) is decreased, the more possible it is to execute a large number of full translation cycles per time period, which encourages the application of homogeneous average environmental conditions to the plants held by the movable holders (15).

To execute step c1) of translation T3, one actuates:
the translation means (51), or right thruster, equipping the end of the row R located on the side of edge (14) of plate (10), and whose thrust plane is translated along an axis that is parallel to the axis of the row R, in a direction running from edge (14) towards edge (12) of plate (10). The course of the translational movement of right thruster (51) is customized to cause the translation of movable holder (15) located opposite its thrust plane, from a position Z to a position Z+1.

To execute step c2) of translation T4, one actuates, simultaneously or at different times:
the translation means (52), or upper arms, equipping the end of each of the uneven columns C1 through CN−1 located on the side of the edge (13) of the plate (10), and whose thrust plane is translated along an axis that is parallel to the axis of the columns C1 through CN in a direction running from the edge (12) towards the edge (14) of the plate (10). The course of the translational movement of the upper arms (52) is customized to cause the translation of the movable holder (15) located opposite its thrust plane, from a position Z to a position Z+1.

To execute step c3) of translation T5, one actuates, simultaneously or at different times:
the translation means (53), or bottom arms, that equip the end of each of the even-numbered columns C2 through CN−2 located on the side of the edge (11) of the plate (10), and whose thrust plane is translated along an axis that is parallel to the axis of columns C1 through CN in a direction running from the edge (12) towards the edge (14) of the plate (10). The course of the translational movement of the bottom arms (53) is customized to cause the translation of the movable holder (15) located opposite its thrust plane, from a position Z to a position Z+1.

As has already been indicated, steps c1), c2), and c3) can be performed (i) all at the same time, (ii) two steps simultaneously and a third step separate from the two others, or (iii) all three steps at different times. However, steps c1), c2), and c3) are preferably performed simultaneously in order to decrease the total duration of Step c). In the embodiments of the method wherein steps c1), c2), and c3) are performed at different times, the order in which steps c1), c2), and c3) are executed is irrelevant.

As has already been indicated, steps b) and c) are performed separately, the order of execution of steps b) and c) being irrelevant.

### Step d) of the Method

As has been indicated previously, executing the combination of steps b) and c) above enables the advancement by one step of all of the movable holders (15) placed in the loop circuit on the surface of the plate (10). Each movable holder (15) then moves from a start position Z to an arrival position, Z, Z+1, or Z+2, depending upon the relevant movable holder (15) and its location in relation to any empty spaces, with Z being a whole number equal to all of the possible positions of the movable holders (15) in said loop circuit on the surface of the plate (10). After the sequence of a step b) and a step c), the system is ready to take another step.

As has also been indicated previously, a movable holder (15) has made a full translation cycle in the closed circuit on the surface of the plate (10) when said movable holder (15) has consecutively occupied the possible positions Z, and when, at the next translation step, said movable holder (15) will again assume the position that it had at the beginning of the first execution of step b) or c) of the cultivation or phenotyping method of the invention.

When the automaton is being used optimally, that is, when the closed circuit on the surface of the plate (10) includes the maximum possible number of movable holders (15) enabling execution of the cultivation or phenotyping method, a full cycle for translating the movable holder (15) is performed after Z executions of the combination of steps b) and c) described above.

In step d) of the method, steps b) and c) are repeated a sufficient number of times to execute a full displacement cycle of the movable holders (15) along the loop circuit on the surface of the plate (10). In the optimal embodiment of the method, for which the number of movable holders (15) placed on the surface of the plate (10) is such that all of said movable holders are translated upon each execution of a combination of steps b) and c), the combination of steps b) and c) is executed Z times, and Step d) is consequently executed Z−1 times.

### Step e) of the Method

During step e) of the method, step d) is repeated a sufficient number of times to execute as many full cycles for translating the movable holders (15) in the loop circuit on the surface of the plate (10) as desired. Hence, if one wishes to perform Y full cycles for translating the movable holders (15) during the cultivation or phenotyping method, Step e) is performed Y−1 times.

It will be clear to the expert that the primary advantage provided by the cultivation or phenotyping method of the invention is obtaining the most uniform environmental conditions possible for the entire population of cultivated plants. The goals sought by the invention are achieved when, on average over time, each cultivated plant has experienced environmental conditions, e.g., relative humidity, temperature, and lighting, that are identical or roughly identical. Therefore, in order to execute successfully the cultivation or phenotyping method of the invention, it is not mandatory for the plants placed on the movable holders (15) to be in continuous movement throughout the entire duration of said method. The displacement speed of the movable holders (15) on the surface of the plate (10) is selected by the user, based on the constraints or instructions for the cultivation or phenotyping assay to be performed.

The ratio between (i) the duration of the actual translation steps of the movable holders (15) over the execution of the cultivation or phenotyping method of the invention and (ii) the method's total duration of execution may be highly variable and may be selected by the user.

In certain embodiments of the method, wherein one wishes to execute continuous or near-continuous displacement of the plants on the surface of the plate (10), said method is executed with a large ratio between (i) the duration of the actual translation steps of the movable holders (15) during execution of the cultivation or phenotyping method of the invention and (ii) the total duration of the method's execution. For example, when actual translation steps b) and c) have a duration ranging from 0.5 to approximately 2 seconds, a pause or idle time of about the same duration is applied before repeating the combination of steps b) and c); that is, before executing Step d) of the method. In these embodiments, applying a brief pause time causes a high execution frequency of step d) and continuous or near-continuous movement of the movable holders (15) on the surface of the plate (10).

In other embodiments of the method, wherein one does not wish to execute continuous or near-continuous displacement of the plants on the surface of the plate (10), said method is executed with a reduced ratio between (i) the duration of the actual translation steps of the movable holders (15) during execution of the cultivation or phenotyping method of the invention and (ii) the total duration of the method's execution. For example, when actual translation steps b) and c) have a duration ranging from 0.5 to approximately 2 seconds, a pause or idle time of a selected variable duration may be applied, e.g., ranging from 10 seconds to 10 minutes, before repeating the combination of steps b) and c); that is, before executing step d) of the method. In these embodiments, applying a long pause time causes a decreased execution frequency of step d) and makes the movement of the movable holders (15) on the surface of the plate (10) less smooth.

As has been explained previously, it is important to provide the plants with a consistent water supply in order to ensure their viability, along with a consistent fertilizer solution supply in order to ensure their growth. Therefore, the method preferably includes an additional step for supplying water and/or fertilizer solution to the cultivation substrate holding a plant placed inside a movable holder (15) during at least one cycle repeating steps b) and c).

This additional step is performed at the end of one of steps b) or c), based on where the water or fertilizer solution means are located along the route. For several distribution means installed at various spots along the plant route, these means must be installed such that they can all carry out their role at the same moment of the method. If this is not done, it is still possible to separate them at the method level, but this will make the method more complex and will involve changing the instructions inside the supervisory computer.

As has been specified previously, this step is generally paired with weighing steps: one, performed prior to the distribution, makes it possible to adjust the quantity of water and/or liquid fertilizer solution delivered to the plant; and the other, performed thereafter, checks the quantity actually delivered.

Since the automaton is preferably placed inside a plant cultivation enclosure, the method is likewise preferably performed inside a plant cultivation enclosure. Preferably, in this embodiment of the method, at least one physical condition of the cultivation enclosure's internal environment, selected from relative humidity, temperature, and lighting levels, is controlled. Atmospheric pressure can also be controlled inside the enclosure, or the chemical composition of the internal atmosphere of the enclosure, or any other physical parameter that is likely to influence plant growth.

It is the possibility of controlling the climatic parameters of the cultivation enclosure inside which the plants are located, along with displacing the plants in a loop circuit inside this cultivation enclosure, that enables phenotyping of a plurality of plants under the proper conditions: advantageously, the method includes an additional step for measuring at least one phenotypic characteristic of at least one plant held by a cultivation substrate placed inside a movable holder (15).

In the same way as the water and/or fertilizer solution distribution, measuring a phenotypic characteristic or characteristics must be performed during at least one repetition cycle of steps b) and c), at the end of one of steps b) or c), based on where the measuring means are located along the plant route. For several measuring means installed at various spots along the plant route, these means must be installed such that they can all carry out their role at the same moment of the method. If this is not done, it is still possible to separate them at the method level, but this will make the method more complex and will involve changing the instructions inside the supervisory computer.

Advantageously, the additional step of measuring at least one phenotypic characteristic of a plant consists in a step for measuring the leaf surface area.

A high-quality genetic study requires a large population of plants. This is why step d) is preferably repeated at least 100 times, better still at least 500 times, which means that at least 100 plants, better still at least 500 plants, will be present on the plate (10), assuming that each movable holder (15) holds one plant and its cultivation substrate.

Performing a single full displacement cycle of the movable holders (15) in 24 hours is possible with the automaton of the invention. However, performing a single full displacement cycle of the movable holders (15) in 24 hours will generally be insufficient for overcoming the effect of variations in environmental conditions and for ensuring proper reproducibility of the measurements. The higher the number of cycles performed in 24 hours is, the better the results will be in terms of cultivation condition homogeneity. This is why, preferably, the frequency of step d) is such that at least 2 full displacement cycles of the movable holders (15) per 24 hours are performed. In real-world practice, with an automaton of the invention inside which 700 movable holders (15) with plants are placed, and with a total duration of the combined steps b) and c) of approximately 30 seconds, a full translation cycle of the movable holders (15) on the surface of the plate (10) is performed in slightly less than six hours, which makes it possible to execute four full translation cycles of said holders in 24 hours.

When one or several other possible devices are placed on the plate (10) of the automaton or on its periphery, e.g., a bar code reader, at least one step must be introduced into the method involving this device or these devices, preferably during at least one repetition cycle of steps b) and c).

One of the advantages of the method of the invention is obtaining homogeneous cultivation conditions, as is shown hereinafter in Example 3.

Another of the advantages of the method of the invention is obtaining a genetic analysis tool. Indeed, in certain embodiments of the method of the invention, it is possible to cultivate two plants that only differ from each other by a single gene, with the entire remainder of their genome being identical. During cultivation, a given phenotypic trait, e.g., leaf growth speed, is measured. If the measurement values are identical for both plants, which means that the phenotype does not vary, then the gene in question does not influence this trait. Conversely, if these values are different, then the gene in question is involved in controlling this trait. In other embodiments of the method of the invention, it is also possible to cultivate plants without knowing whether they are genetically identical or not. It is the measurement of this same phenotypic trait that will yield a conclusion. If the plants are not genetically identical, it is because the genes for which they differ, and that can be identified, play a role in this trait's organization. Lastly, the method of the invention makes it possible to cultivate numerous plants and to repeat experiments under globally identical conditions, which makes it possible to target not just a single gene but numerous genes, as well as traits controlled not just by a single gene but by numerous genes.

The characteristics and advantages of the invention will be more fully understood via the following examples, provided for nonlimiting illustrational purposes.

### EXAMPLES

### Example 1

### Displacing Movable Holders in One Embodiment of the Method

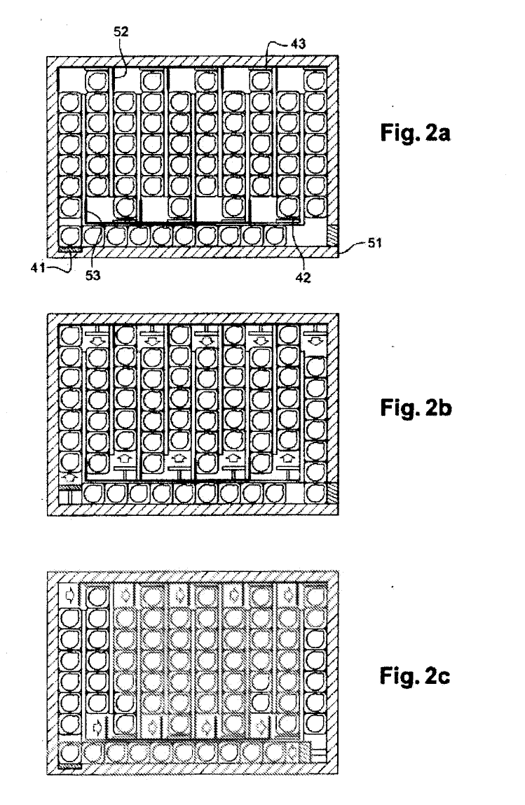

This example is illustrated by the three top-view diagrams in FIG. 2.

FIG. 2a) reprises the specific embodiment of the automat presented in FIG. 1. In this embodiment, N is equal to 10, A is equal to 11, and B is equal to 7. Therefore, these parameters limit the automaton's displacement capacity to, at most, 71 movable holders (15), which are present on the plate (10) of the automaton. This configuration of the plate (10) corresponds to one of the required initial positions, since any subsequent translation is possible, whether vertical or horizontal, since no motion of the translation means can be interfered with.

FIGS. 2b) and 2c) correspond to the step for displacing the movable holders (15) by one step, which consists in performing a sequence of ones b) and one step c).

Step b) is a step for vertical translation of a subset of the movable holders (15) along the axis of columns C1 through CN. In the case presented in FIG. 2b), the left thruster and the top and bottom rods are actuated simultaneously, which means that steps b1) and b2) are performed simultaneously. Once their movement is effected, these translation means resume their initial position, and the system has then taken one-half step.

The displacement of the movable holders (15) then continues with a step c) for horizontal translation of a subset of the movable holders (15) along the axis of the row R. In the case presented in FIG. 2c), the right thruster or “return thruster” and the top and bottom arms are actuated simultaneously, which means that steps c1), c2), and c3) are performed simultaneously. Once their movement is effected, these translation means resume their initial position, and the system has then taken a second half-step.

Over the course of the displacements illustrated in FIGS. 2b) and 2c), the system has therefore taken one step, and is then ready to take another step, by again sequencing one step b) and one step c). In the specific case presented here, the configuration of the movable holders (15) on the plate (10) of the automaton at the end of step c) is identical to that of the movable holders (15) at the beginning of step b), with the only difference being that the holder numbered S has been replaced by the following holder numbered S+1. This is due to the fact that the number of movable holders (15) that are actually present on the plate is equal to the maximum number of movable holders that the automaton can hold.

### Example 2

### Example of a Set of Command and Control Instructions for the Plant Cultivation or Phenotyping Assay Facility

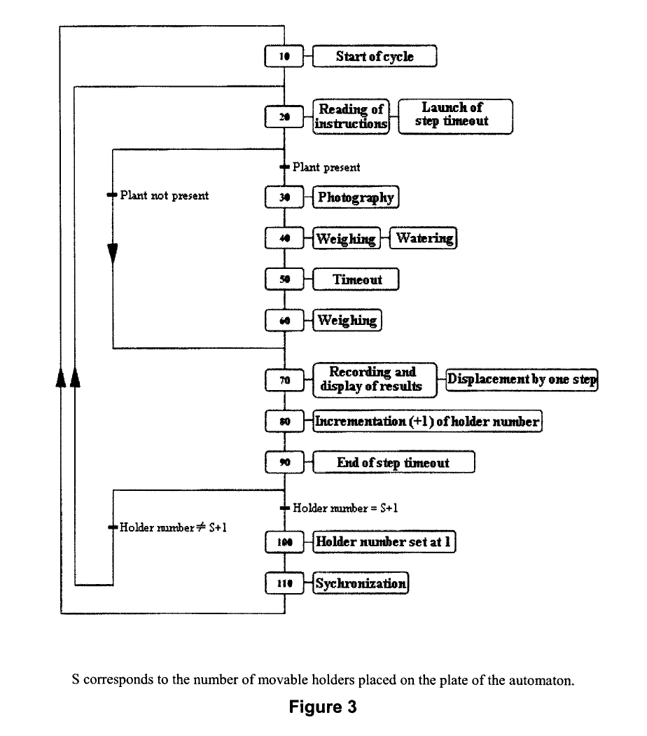

This example is illustrated by the diagram in FIG. 3, which shows a sequence of steps for controlling and commanding the plant cultivation or phenotyping automaton; the sequence is loaded into a data storage means of the facility of the invention's digital calculator.

The sequence of control and command instructions was programmed using the RSView®32 software program sold by Rockwell Automation (Milwaukee, Wis., U.S.A.).

### Step 10

In this method, the cycle for displacing the movable holders (15) begins in step 10 by starting up a cycle after the user has positioned the movable holders (15) as initially required; the number of holders is equal to S. In other words, at the end of step 10, step a) of the method of the invention has been performed and the automaton's configuration has been initialized in order to begin the first full movable holder (15) translation cycle out of all of the cycles that will be performed during the cultivation or phenotyping assay.

### Step 20

In step 20, the processor of the digital calculator, or “supervisory computer,” reads the control and command instructions and also launches the timeout for the step.

The control and command instructions consist in a set of instructions required for the proper execution of the cultivation or phenotyping method by the various means with which the facility is equipped, and that are loaded into the memory of the digital calculator (100).

Among these instructions are the correspondences between the number of the holder and the presence of a plant, previously entered by the user. Therefore, the automaton knows exactly which holder is holding which plant.

If no plant is present in the movable holder under consideration, then the system moves on directly to step 70, which involves recording and, if applicable, displaying results. Otherwise, the cycle continues with step 30, involving photography.

### Step 30

In step 30, the processor of the digital calculator controls the acquisition of one or several images, generally in top view, of the movable holder No. 1 positioned within the photographic lens' field of view. The digital data of the image are (i) either stored temporarily in the memory of the image acquisition device, (ii) or transmitted to an external data storage means, generally a data storage means in the digital calculator.

In certain embodiments of the method, the image data contained in the memory of the digital calculator are processed by an image analysis program containing instructions necessary for detecting or calculating one or several values of phenotypic characteristics of the corresponding plant, such as the plant's height, leaf surface area, stem or leaf shape, leaf or stem color, etc. The characteristic phenotype values calculated in this way can be stored separately in the memory of the digital calculator so that they can be used at a later date, e.g., in calculations for comparing these values among plants, at a given cycle of the method, or for comparing these same values for the same plant but for successive cycles of the method.

### Step 40

Step 40 is the step for weighing, watering, and/or fertilizing the plant, with the quantity of water and/or fertilizer solution delivered to the plant being adjusted by the digital calculator's commands, based on the weight of the movable holder being measured and the set point values stored inside the digital calculator's memory.

### Step 50

Step 50 consists in a “timeout” step, during which the system does not perform any operations. This step, which is generally very brief, stabilizes the means (110) for weighing the movable holders (15) after they are watered.

### Step 60

After the timeout in step 50, due to the time required for watering, the movable holder is weighed again in step 60. This is to verify that the quantity of water and/or fertilizer solution that was actually delivered to the plant corresponds to the predetermined set point values.

### Steps 70 and 80

Step 70 consists in storing information in the digital calculator's memory and performing a one-step displacement.

For a movable holder that does not contain a plant, step 70 only involves recording, in the digital calculator's memory, the information that a plant is absent.

Conversely, for a movable holder that does contain a plant, steps 30 through 60 have been performed. Therefore, weighing and delivery of water and/or fertilizer solution have already occurred. In this case, the weighing information, before and after delivery of water and/or fertilizer solution, as well as, if applicable, the operational information from the actuated pump or pumps, are stored in the digital calculator's memory.

In certain embodiments, at least some of the above information is displayed, e.g., on the screen with which the digital computer is equipped, or on another display device with which the system may be equipped.

While the results are being recorded and displayed, the movable holders (15) are displaced by one step, and the number of the holder is then incremented in Step 80 and is designated as 2 thereafter.

Steps 90 through 110

Step 90 corresponds to the end of the step timeout. This step sets the time period of the step such that the movable holders (15) complete a full movable holder (15) displacement cycle within the allotted time.

Since the number of movable holder No. 2 is different from S+1, the system returns to step 20 and repeats, for all of the successive movable holders, the procedure previously described for movable holder No. 1.

When, at the end of step 80, the number of the holder is equal to S+1, this is because a full movable holder displacement cycle has been performed, and, in Step 100, the number of the movable holder designated as S+1 is again set at 1.

Following step 110, involving synchronization with the start signal, a new cycle begins, at the desired time, at step 10.

### Example 3

### Results Obtained by the Method of the Invention

This example is illustrated by the two graphs in FIG. 4 (FIGS. 4A and 4B), both of which illustrate the cumulative weight loss (in grams) on days J1 through J4 for each clod out of 735, which undergo either one or six 4-hour displacement cycles per day.

Example 3 is also illustrated by the two graphs in FIG. 5, which present the weight loss curves after 24 hours (in grams per clod) for a set of 735 clods that undergo either one (fixed pots) or six (rotating pots) 4-hour displacement cycles per day.

The experiment is performed in a controlled environment, inside a plant cultivation enclosure.

In this example, the method followed is similar to the method described above in Example 2, except that the watering step does not occur in step 30.

The embodiment of the method wherein six full displacement cycles of the movable holders are performed per day is one of the optimal embodiments of the invention, during which the plants circulate without stopping for any length of time on the plate (10) of the automaton placed inside a cultivation enclosure. Conversely, this is no longer true for the case of a single 4-hour displacement cycle per day, wherein the plants remain immobile at a specific location on the plate (10) of the automaton for 20 hours, and only circulate for 4 hours. This situation makes it possible to evaluate the efficacy of the method of the invention by focusing on the hydric loss of the clods placed on the plate.

In the case of a single 4-hour displacement cycle per day:
in FIG. 4A, we can see a wide variation in the weight losses measured among the various clods, with the difference in weight loss among the holders reaching up to 5 g on day J1, then up to 10 g on days J2 through J4, despite the fact that the automaton is placed inside a cultivation enclosure whose physical parameters such as lighting, relative humidity, and temperature are controlled;
In FIG. 5 (fixed pots), we can also see a broad heterogeneity in weight loss after 24 hours among the clods, which vary unequally from 5 to 11 g/clod. Consequently, depending upon their initial placement on the plate (10), the plants undergo different climatic conditions that are responsible for differences in hydric loss that are unacceptable for a phenotypic study.

Conversely, in the case of six 4-hour displacement cycles per day:
in FIG. 4B, the measured weight losses are much more homogeneous among the various clods;
in FIG. 5 (rotating pots), the weight losses of the clods after 24 hours are much more homogeneous, following a Gaussian-type distribution centered around approximately 7.5 g/clod.

When seen in graph form, the differences in results between the two experiments are especially noticeable, in both FIG. 4 and FIG. 5.

1-20. (canceled)

21. An automaton useful to cultivate or phenotype a plurality of plants in a controlled environment which comprises:
(a) a plate marked off, respectively, by four sides with raised edges; respectively, a lower-edged side, a left-edged side, an upper-edged side, and a right-edged side, and having a surface;
(b) a plurality of moveable holders installed on said plate wherein said plurality of moveable holders are able to assume, consecutively, all possible positions on the surface of said plate;
wherein the surface of the plate includes:
a row marked off, respectively, by the raised edge of the lower-side of the plate and a first guide parallel to said raised edge of the lower-side of the plate, with the ends of the guide being far enough away from the edges of the left side and the right-side of the plate to enable a movable holder to pass through, and
a plurality of N adjacent columns, designated C1 through CN, perpendicular to the row and marked off by the two raised edges of the left-side and the right-side, respectively, of the plate and by an intervening plurality of N−1 guides perpendicular to the lower-edge side of the plate;
wherein the plurality of guides includes:
a first group of (N/2) guides wherein each guide of the first group includes two ends with one end in contact with the first guide, and the other end being far enough away from the raised edge of the upper-side of the plate to enable a movable holder to pass through, and
a second group of (N/2)−1 guides wherein each guide of the second group is inserted between two successive guides of the first group, and includes two ends with one end in contact with the raised edge of the upper-side of the plate and the other end being far enough away from the first guide to enable a movable holder to pass through, where N is an even number,
(c) a first means for translating the plurality of movable holders along an axis that is parallel to the first and second group of guides comprising, respectively:
a first means located, when at rest, at the end of the raised edge of the lower-side of the plate that is in contact with the raised edge of the left-side of the plate, for translating the plurality of movable holders in a direction running from the raised edge of the lower-side of the plate towards the raised edge of the upper-side of the plate, along column C1 marked off by the raised edge of the left-side of the plate and a first adjacent intervening guide,
a first series of means for translating the plurality of movable holders in a direction running from the first guide parallel to the raised edge of the lower-side of the plate towards the raised edge of the upper-side of the plate, along each of the odd-numbered columns C3 through CN−1, and
a second series of means for translating the plurality of movable holders in a direction running from the raised edge of the upper-side of the plate towards the raised edge of the lower-side of the plate, along each of the even-numbered columns C2 through CN, and
(d) a second means for translating the plurality of movable holders along an axis parallel to the row comprising, respectively:
a first means located, when at rest, at the end of the raised edge of the right-side of the plate that is in contact with the raised edge of the lower-side of the plate, for translating the plurality of movable holders in a direction running from the raised edge of the right-side of the plate towards the raised edge of the left-side of the plate, along the row marked off by the raised edge of the lower-side of the plate and the adjacent first guide,
a first series of means located in each of the odd-numbered columns C1 through CN−1 at the end of each column which is adjacent to the raised edge of the upper-side of the plate, for translating the plurality of movable holders towards the adjacent end of the adjacent even-numbered column C2 through CN, and
a second series of means located in each of the even-numbered columns C2 through CN−2 at the end of each column which is adjacent to the first guide, for translating the plurality of movable holders towards the adjacent end of the adjacent odd-numbered column C3 through CN−1.

22. The automaton of claim 1, wherein at least 100 movable holders are installed on the surface of the plate.

23. The automaton of claim 1 which is equipped with at least one means for weighing a movable holder.

24. The automaton of claim 1, wherein a cultivation substrate holding a plant is placed in one or more of the movable holders.

25. The automaton of claim 24 which is equipped with at least one means for supplying water or fertilizer solution to a cultivation substrate holding a plant placed in one or more of the movable holders.

26. The automaton of claim 25, which is further equipped with a means for weighing the moveable holders and wherein said water or fertilizer solution supply means is located plumb with said means for weighing.

27. The automaton of claim 1, which is equipped with at least one means for measuring a phenotypic characteristic of a plant.

28. The automaton of claim 27, wherein said measuring means comprises an image acquisition device.

29. The automaton of claim 27, which is further equipped with at least one means for measuring a phenotypic characteristic of a plant.

30. A facility for cultivating or phenotyping a plurality of plants in a controlled environment, comprising:
an automaton of claim 1, and
at least one control and command means for the first and second means for translating the plurality of moveable holders.

31. The facility of claim 30, wherein:
said automaton is equipped with at least one means for weighing a movable holder and at least one means for delivering water or fertilizer solution, wherein the at least one means for delivering water or fertilizer solution is located plumb with the at least one means for weighing movable holders, and
said facility further comprises at least one control and command means connected to said at least one weighing means and at least one control and command means connected to said at least one water or fertilizer solution delivery means, enabling adjustment of the quantity of water, fertilizer solution, or both delivered based on the measured weight of a movable holder.

32. The facility of claim 31 wherein:
said automaton is further equipped with at least one means for measuring a phenotypic characteristic of a plant, and
said facility further comprises at least one control and command means for said phenotypic characteristic measuring means and at least one means for storing data generated by said phenotypic characteristic measuring means.

33. The facility of claim 32, wherein:
said automaton is placed inside a plant cultivation enclosure, and
said facility further comprises at least one means for controlling and commanding at least one physical condition of the environment inside the plant cultivation enclosure, said condition selected from relative humidity, lighting, and temperature level.

34. The facility of claim 30 wherein:
the automaton is further equipped with at least one means for measuring a phenotypic characteristic of a plant, and
said facility further comprises at least one control and command means for said phenotypic characteristic measuring means and at least one means for storing data generated by said phenotypic characteristic measuring means.

35. A method for cultivating, phenotyping or both of a plurality of plants in a controlled environment, wherein each of the plants to be cultivated is held by a cultivation substrate placed inside one of a plurality of movable holders on the surface of a plate whose surface is divided, respectively, into:
a row R located along a first edge of the plate that has two opposite ends,
a plurality of N adjacent columns, designated C1 through CN, perpendicular to the row R, with each of the columns having two opposite ends,
wherein the first column C1 communicates, at its first end, via an opening large enough for the movable holders to pass through, with the first end of the row R, and, at its other end, via an opening large enough for the movable holders to pass through, with the following adjacent column C2,
wherein the Nth column CN communicating, at its first end, via an opening large enough for the movable holders to pass through, with the opposite end of the row R, and, at its other end, via an opening large enough for the movable holders to pass through, with the preceding adjacent column CN−1,
with each of the remaining columns C2 through CN−1 communicating, at one of its ends, via an opening large enough for the movable holders to pass through, with a preceding adjacent column, and at its other end, via an opening large enough for the movable holders to pass through, with a following adjacent column,
with each of the plurality of movable holders being able to assume, consecutively, all of the possible positions on the surface of said plate, respectively:
any position R1 through RA within said row R located along said first edge of the plate with A being equal to the maximum value of the number of movable holders to be contained in said row R,
any position CX1 through CXB within a column CX of said plurality of columns, where X is a whole number ranging from 1 to N, where N is an even number, and where B is equal to the maximum value of the number of movable holders to be contained in a column CX,
said method comprising the steps of:
a) initializing a displacement cycle of the plurality of movable holders by positioning said plurality of movable markers on the surface of the plate in such a way to enable any vertical translation, any horizontal translation or both during the subsequent step,
b) performing a step of vertical translation of a subset of the plurality of movable holders along the axis of the columns C1 through CN, with said step including:
b1) a translation T1 of any of the plurality of movable holders contained in the even-numbered columns C2 through CN towards the row R, and
b2) a translation T2 of any of the plurality of movable holders contained in the odd-numbered columns C1 through CN−1 in the direction that is opposite the translation direction T1, wherein steps b1) and b2) can be performed simultaneously or separately in any order;
c) performing a step of horizontal translation of a subset of the plurality of movable holders along the axis of the row R, with said step including:
c1) a translation T3 of any of the plurality of movable holders contained in the row R in the direction of the horizontal axis passing consecutively through columns CN through C1,
c2) a translation T4 of any of the plurality of movable holders in each of the columns C1 through CN-1 and located at the end of each column opposite the row R in a direction along the axis passing consecutively through columns C1 through CN, and
c3) a translation T5 of any of the plurality of movable holders in of each of the columns C2 through CN−2 and located at the end of the column adjacent row R in a direction along the axis passing consecutively through columns C1 through CN, wherein steps c1), c2) and c3) can be performed simultaneously or separately, in any order, and
wherein steps b) and c) can be performed separately in any order,
d) repeating steps b) and c) a sufficient number of times for each of the plurality of movable holders to have assumed, at the end of the last repetition cycle of steps b) and c) consecutively, all of the possible positions on the surface of said plate, such that a full displacement cycle of the plurality of movable holders has been performed,
e) repeating step d) for a sufficient number of cycles to cultivate, phenotype or both the plurality of plants.

36. The method of claim 35 which further comprises a step of delivering water, fertilizer solution or both to the cultivation substrate holding a plant placed inside one or more of the plurality of movable holders during at least one repetition cycle of steps b) and c), with said additional step being performed at the end of either step b) or c).

37. The method of claim 36 which is performed inside a plant cultivation enclosure.

38. The method of 35 wherein at least one physical condition of the cultivation enclosure's internal environment, selected from relative humidity, temperature, and lighting levels, is controlled.

39. The method of claim 35 further comprising a step for measuring at least one phenotypic characteristic of at least one plant supported by the cultivation substrate placed inside the one or more of the plurality of movable holders during at least one repetition cycle of steps b) and c), with said additional step being performed at the end of either step b) or c).

40. The method of claim 39 wherein the step of measuring at least one phenotypic characteristic of a plant is a step for measuring leaf surface area.

41. The method of claim 35 wherein step d) is repeated at least 100 times.

42. The method of claim 35 wherein the frequency of step d) is such that at least 2 full cycles for displacing the plurality of movable holders are performed every 24 hours.
